(19) United States
(12) Patent Application Publication
(10) Pub. No.: US 2025/0118221 A1
(43) Pub. Date: Apr. 10, 2025

(54) METHOD AND SYSTEM FOR MATH EDUCATION USING DICE

(71) Applicant: Chace PEMBROKE, Twin Lakes, WI (US)

(72) Inventor: Chace PEMBROKE, Twin Lakes, WI (US)

(21) Appl. No.: 18/983,953

(22) Filed: Dec. 17, 2024

Related U.S. Application Data
(60) Provisional application No. 63/611,250, filed on Dec. 18, 2023.

(51) Int. Cl. G09B 19/02; G09B 5/02

(52) U.S. Cl. CPC G09B 19/025; G09B 5/02

(57) ABSTRACT

A method and system for math education using dice. A first type of dice includes mathematical operations and one or more other emojis to activate a second type of dice when rolled. The second type of dice including bonus points and penalty points for making math calculations using the mathematical operations from the first dice when rolled. The second type of dice also includes one or more second emojis to activate a third dice including one or more third emojis to provide an automatic winner or automatic loser of the math game when rolled. The three different types of dice provide dynamic and different outcomes based on probabilities and possibilities of different dice faces occurring when rolled.

### CROSS REFERENCES TO RELATED APPLICATIONS

This U.S. utility patent application claims priority to U.S. provisional patent application No. 63/611,250, filed on Dec. 18, 2023, the contents of all of which are incorporated by reference.

### FIELD OF INVENTION

This invention relates to educational systems for math. More specifically, it relates to a method and system for math education using dice.

### BACKGROUND OF THE INVENTION

Mathematics is the long word for “math,” or the science of numbers and what they mean. Most people need mathematics every-day to count and measure.

Math is a very difficult subject to learn for many people. Mathematics education is referred to as the practice of teaching and learning of mathematics in a way of solving problems involving learning the algorithms and formulas necessary for computations.

Teaching math is often difficult because it's educator's mission to provide experiences for students to build their own math proficiencies. In most instances math is not practiced outside a classroom setting.

Math is often taught to allow students to engage, explore, explain, elaborate, and evaluate.

Teaching methods of mathematics include lecture, inductive, deductive, heuristic or discovery, analytic, synthetic, problem solving, laboratory and project methods.

Teaching math also includes teaching math with games. Game-based math learning boosts students' ability to reason, understand underlying concepts, and find solutions to complex math problems. Educational games motivate students to find creative solutions and drive them to accelerate their learning, having fun.

There are several problems with using games to teach math. One problem is that many math games are repetitive causing students to lose interest.

Another problem is that many math games to not include mechanisms to provide dynamic changes to the math game each time it is played.

Another problem is that many math games use dice. However, in such math games, only numbers on the dice faces are used to teach math.

Another problem is that many math games typically only use two number dice to teach math.

Another problem is that many math games do not other dice with other symbols leading to activating other rolls of dice with different symbols providing different outcomes in the math game.

However, there are few solutions to solve all of the problems associated with math education using dice. Thus, it is desirable to solve some of the problems associated with math education using dice.

### SUMMARY OF THE INVENTION

In accordance with preferred embodiments of the present invention, some of the problems associated with math education are overcome. A method and system for math education using dice is presented.

Math education is provided with a math game using three different types of dice. A first type of dice includes mathematical operations and one or more other emojis to activate a second type of dice when rolled. The second type of dice including bonus points and penalty points for making math calculations using the mathematical operations from the first dice when rolled. The second type of dice also includes one or more second emojis to activate a third dice including one or more third emojis to provide an automatic winner or automatic loser of the math game when rolled. The three different types of dice provide dynamic and different outcomes based on probabilities and possibilities of different dice faces occurring when rolled.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary math education system;

FIG. 2 is a block diagram illustrating an exemplary math education display system;

FIG. 3 is a block diagram illustrating an exemplary networking protocol stack;

FIG. 4 is a block diagram illustrating an exemplary cloud communications network;

FIG. 5 is a block diagram illustrating an exemplary cloud storage object;

FIG. 6 is a block diagram illustrating wearable network devices;

FIG. 7 is a block diagram illustrating plural dice used for math education;

FIG. 8 is a flow diagram illustrating a method for math education with a dice game;

FIGS. 9A and 9B are a flow diagram illustrating a method for math education with a dice game;

FIG. 10 is a block diagram illustrating a virtual implementation of math education with a dice game;

FIG. 11 is a block diagram illustrating a physical implementation of math education with a dice game;

FIGS. 12A through 12H are a flow a method for math education with a dice game;

FIG. 13 is a flow diagram illustrating a method for a multi-player math education dice game; and

FIG. 14 is a block diagram illustrating a data flow for a multi-player math education dice game.

### DETAILED DESCRIPTION OF PREFERRED EMBODIMENTS

### Exemplary Math Education System

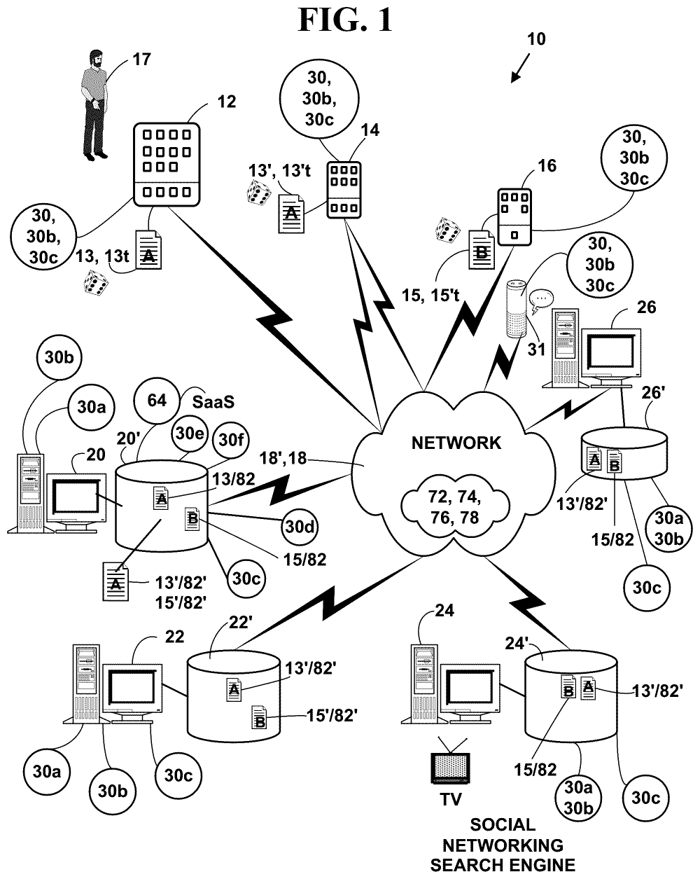

FIG. 1 is a block diagram 10 illustrating a math education system 12.

FIG. 1 is a block diagram illustrating an exemplary math education system 10. The exemplary math education system 10 includes, but is not limited to, one or more target network devices 12, 14, 16, etc. each with one or more processors and each with a non-transitory computer readable medium used by a user 17.

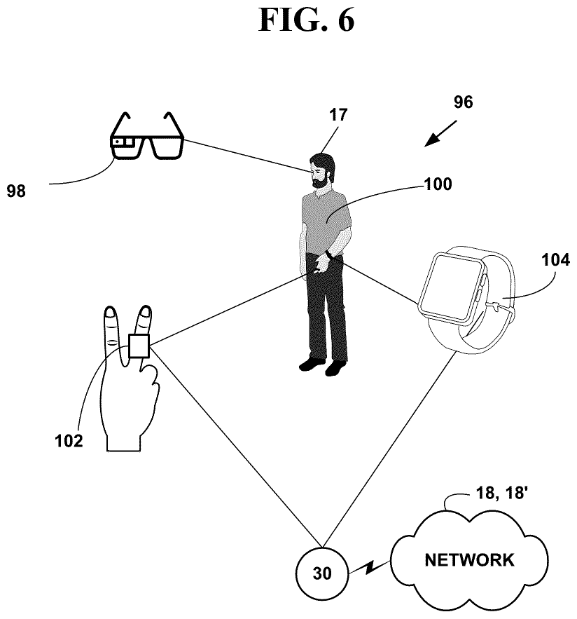

The one or more target network devices 12, 14, 16 (illustrated in FIG. 1 only as a tablet and two smart phones for simplicity) include, but are not limited to, desktop and laptop computers, tablet computers, mobile phones, non-mobile phones with displays, smart phones, Internet phones, Internet appliances, personal digital/data assistants (PDA), portable, handheld and desktop video game devices, Internet of Things (IoT) devices, cable television (CATV), satellite television (SATV) and Internet television set-top boxes, digital televisions including high definition television (HDTV), three-dimensional (3DTV) televisions, wearable network devices 106-112 (FIG. 6), smart speakers 31 and/or other types of network devices.

A “smart phone” is a mobile phone 14 that offers more advanced computing ability and connectivity than a contemporary basic feature phone. Smart phones and feature phones may be thought of as handheld computers integrated with a mobile telephone, but while most feature phones are able to run applications based on platforms such as JAVA ME, a smart phone usually allows the user to install and run more advanced applications. Smart phones and/or tablet computers run complete operating system software providing a platform for application developers.

The tablet computers 12 include, but are not limited to, tablet computers such as the IPAD, by APPLE, Inc., the HP Tablet, by HEWLETT PACKARD, Inc., the PLAYBOOK, by RIM, Inc., the TABLET, by SONY, Inc., etc.

A “smart speaker” 31 is a type of wireless speaker and voice command device with an integrated virtual assistant that offers interactive actions and hands-free activation with the help of one “hot word” (or several “hot words”). Some smart speakers can also act as a smart device that utilizes Wi-Fi, Bluetooth and other wireless protocol standards to extend usage beyond audio playback, such as to control home automation devices. This can include, but is not be limited to, features such as compatibility across a number of services and platforms, peer-to-peer connection through mesh networking, virtual assistants, and others. Each can have its own designated interface and features in-house, usually launched or controlled via application or home automation software. Some smart speakers also include a screen to show the user a visual response.

The IoT network devices, include but are not limited to, security cameras, doorbells with real-time video cameras, baby monitors, televisions, set-top boxes, lighting, heating (e.g., smart thermostats, etc.), ventilation, air conditioning (HVAC) systems, and appliances such as washers, dryers, robotic vacuums, air purifiers, ovens, refrigerators, freezers, toys, game platform controllers, game platform attachments (e.g., guns, googles, sports equipment, etc.), and/or other IoT network devices.

The target network devices 12, 14, 16 are in communications with a cloud communications network 18 or a non-cloud computing network 18′ via one or more wired and/or wireless communications interfaces. The cloud communications network 18, is also called a “cloud computing network” herein and the terms may be used interchangeably.

The plural target network devices 12, 14, 16 make requests 13, 15 for electronic messages (e.g., SMS, MMS, RCS, etc.) for math education via the cloud communications network 18 or non-cloud communications network 18′

The cloud communications network 18 and non-cloud communications network 18′ includes, but is not limited to, communications over a wire connected to the target network devices, wireless communications, and other types of communications using one or more communications and/or networking protocols.

Plural server network devices 20, 22, 24, 26 (only four of which are illustrated) each with one or more processors and a non-transitory computer readable medium include one or more associated databases 20′, 22′, 24′, 26′. The plural network devices 20, 22, 24, 26 are in communications with the one or more target devices 12, 14, 16, 31, 98-104 via the cloud communications network 18 and non-cloud communications network 18′.

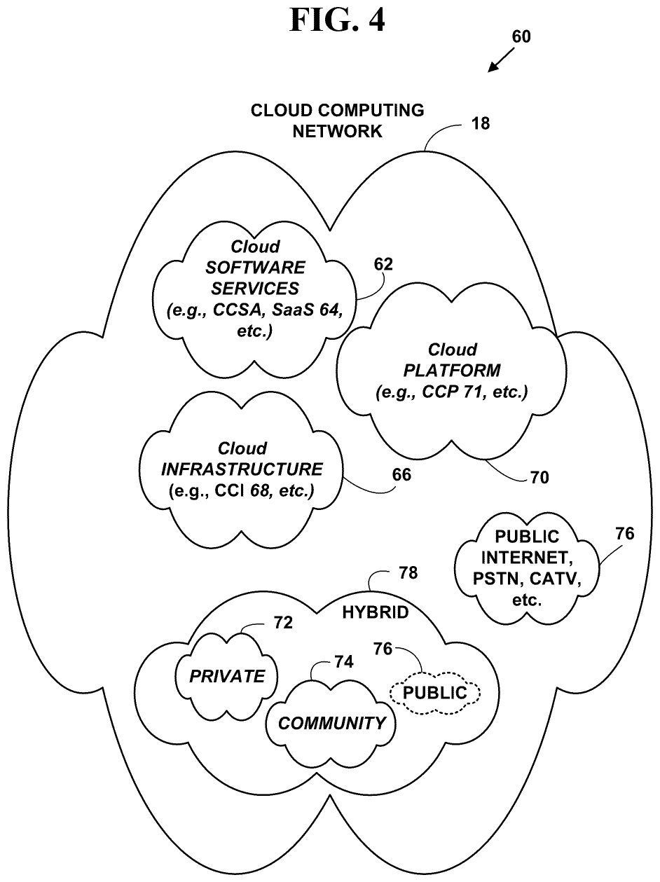

Plural server network devices 20, 22, 24, 26 (only four of which are illustrated) are physically located on one more public networks 76 (See FIG. 4), private networks 72, community networks 74 and/or hybrid networks 78 comprising the cloud network 18.

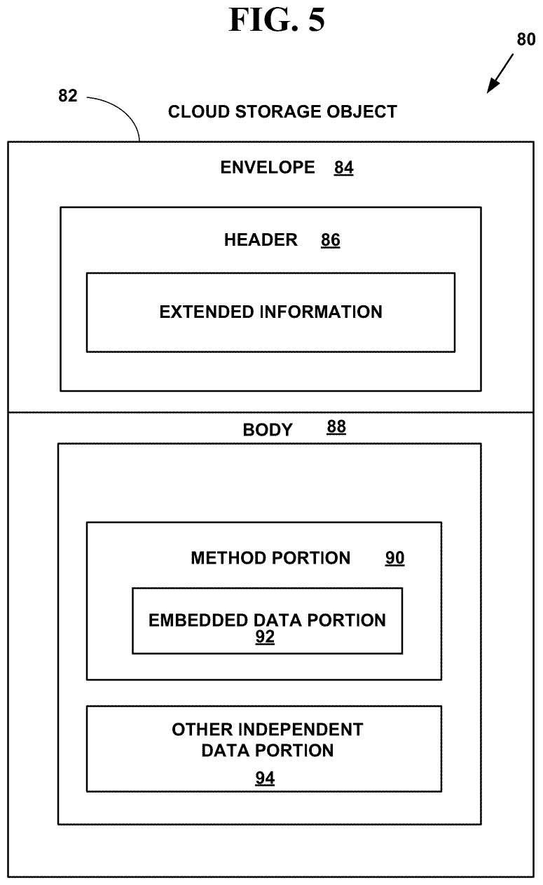

One or more server network devices (e.g., 20, 22, 24, 26, etc.) store portions 13′, 15′ of the electronic content 13, 15 (e.g., SMS, MMS, RCS messages, etc.) for math education as cloud storage objects 82 (FIG. 5) as is described herein.

The plural server network devices 20, 22, 24 26, may be connected to, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for cloud computing providers, etc.

The cloud communications network 18 and non-cloud communications network 18′ includes, but is not limited to, a wired and/or wireless communications network comprising one or more portions of: the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks 18.

The cloud communications network 18 and non-cloud communications network 18′ includes one or more gateways, routers, bridges and/or switches. A gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary electronic information display system 10 include a processing system with one or more high speed Central Processing Unit(s) (CPU), processors, one or more memories and/or other types of non-transitory computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The non-transitory computer readable medium includes cooperating or interconnected computer readable medium, which exist exclusively on the processing system or can be distributed among multiple interconnected processing systems that may be local or remote to the processing system.

### Exemplary Electronic Content Display System

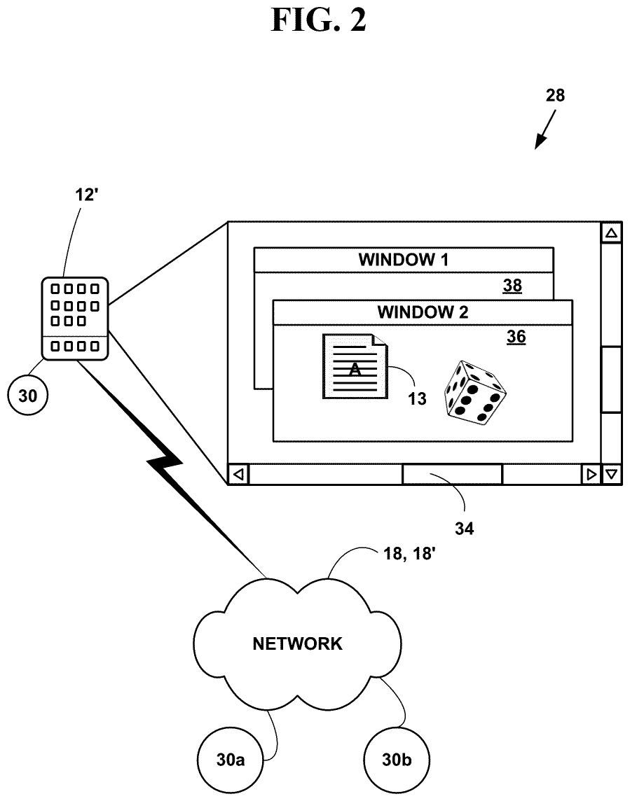

FIG. 2 is a block diagram illustrating an exemplary electronic message information display system 28. The exemplary electronic message information display system 12′ includes, but is not limited to a target network device (e.g., 12, etc.) with an application 30 and a display component 32. The application 30 presents a graphical user interface (GUI) 34 on the display 32 component. The GUI 32 presents a multi-window 36, 38, etc. (only two of which are illustrated) interface to a user.

In one embodiment of the invention, the application 30 is a software application. However, the present invention is not limited to this embodiment and the application 30 can be hardware, firmware, hardware and/or any combination thereof. In one embodiment, the application 30 includes a mobile application for a smart phone, electronic tablet and/or other network device. In one embodiment, the application 30 includes web-browser based application. In one embodiment, the application 30 includes a web-chat client application. In another embodiment, the application 30a, 30b, 30c, 30d, 30e, 30f includes a cloud application used on a cloud communications network 18. However, the present invention is not limited these embodiments and other embodiments can be used to practice the invention

In another embodiment, a portion of the application 30 is executing on the target network devices 12, 14, 16, 31, 98-104 and another portion of the application 30a, 30b, 30c, 30d, 30e, 30f is executing on the server network devices 20, 22, 24, 26. The applications also include one or more library applications. However, the present invention is not limited these embodiments and other embodiments can be used to practice the invention.

### Exemplary Networking Protocol Stack

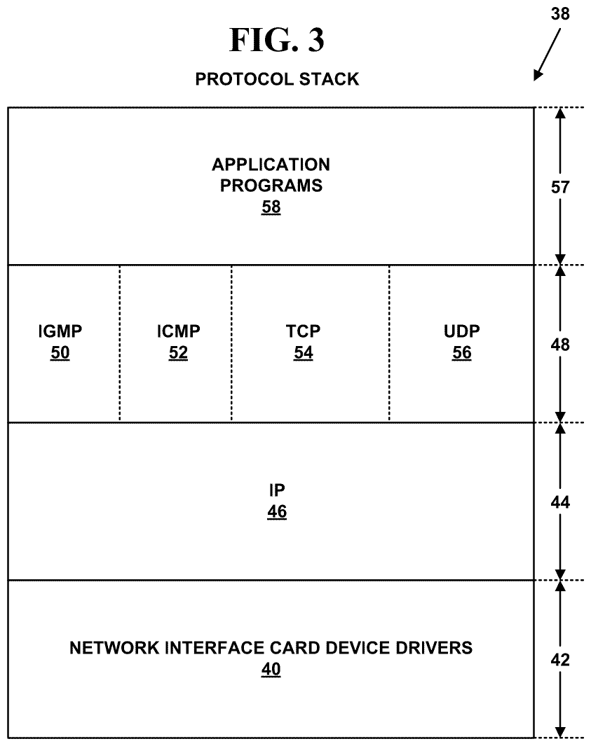

FIG. 3 a block diagram illustrating a layered protocol stack 38 for network devices in the electronic message information display system 10. The layered protocol stack 38 is described with respect to Internet Protocol (IP) suites comprising in general from lowest-to-highest, a link 42, network 44, transport 48 and application 56 layers. However, more or fewer layers could also be used, and different layer designations could also be used for the layers in the protocol stack 38 (e.g., layering based on the Open Systems Interconnection (OSI) model including from lowest-to-highest, a physical, data-link, network, transport, session, presentation and application layer.).

The network devices 12, 14, 16, 20, 22, 24, 26, 31, 98-104 are connected to the communication network 18 with Network Interface Card (NIC) cards including device drivers 40 in a link layer 42 for the actual hardware connecting the network devices 12, 14, 16, 20, 22, 24, 26, 31, 98-104 to the cloud communications network 18. For example, the NIC device drivers 40 may include a serial port device driver, a digital subscriber line (DSL) device driver, an Ethernet device driver, a wireless device driver, a wired device driver, etc. The device drivers interface with the actual hardware being used to connect the network devices to the cloud communications network 18. The NIC cards have a medium access control (MAC) address that is unique to each NIC and unique across the whole cloud network 18. The Medium Access Control (MAC) protocol is used to provide a data link layer of an Ethernet LAN system and for other network systems.

Above the link layer 42 is a network layer 44 (also called the Internet Layer for Internet Protocol (IP) suites). The network layer 44 includes, but is not limited to, an IP layer 46.

IP 46 is an addressing protocol designed to route traffic within a network or between networks. However, more fewer or other protocols can also be used in the network layer 44, and the present invention is not limited to IP 46. For more information on IP 46 see IETF RFC-791, incorporated herein by reference.

Above network layer 44 is a transport layer 48. The transport layer 48 includes, but is not limited to, an optional Internet Group Management Protocol (IGMP) layer 50, a Internet Control Message Protocol (ICMP) layer 52, a Transmission Control Protocol (TCP) layer 52 and a User Datagram Protocol (UDP) layer 54. However, more, fewer or other protocols could also be used in the transport layer 48.

Optional IGMP layer 50, hereinafter IGMP 50, is responsible for multicasting. For more information on IGMP 50 see RFC-1112, incorporated herein by reference. ICMP layer 52, hereinafter ICMP 52 is used for IP 46 control. The main functions of ICMP 52 include error reporting, reachability testing (e.g., pinging, etc.), route-change notification, performance, subnet addressing and other maintenance. For more information on ICMP 52 see RFC-792, incorporated herein by reference. Both IGMP 50 and ICMP 52 are not required in the protocol stack 38. ICMP 52 can be used alone without optional IGMP layer 50.

TCP layer 54, hereinafter TCP 54, provides a connection-oriented, end-to-end reliable protocol designed to fit into a layered hierarchy of protocols which support multi-network applications. TCP 54 provides for reliable inter-process communication between pairs of processes in network devices attached to distinct but interconnected networks. For more information on TCP 54 see RFC-793, incorporated herein by reference.

UDP layer 56, hereinafter UDP 56, provides a connectionless mode of communications with datagrams in an interconnected set of computer networks. UDP 56 provides a transaction oriented datagram protocol, where delivery and duplicate packet protection are not guaranteed. For more information on UDP 56 see RFC-768, incorporated herein by reference. Both TCP 54 and UDP 56 are not required in protocol stack 38. Either TCP 54 or UDP 56 can be used without the other.

Above transport layer 48 is an application layer 57 where application programs 58 (e.g., 30, 30a, 30c, 30b, 30c, 30d, etc.) to carry out desired functionality for a network device reside. For example, the application programs 58 for the client network devices 12, 14, 16, 31, 98-104 may include web-browsers or other application programs, application program 30, while application programs for the server network devices 20, 22, 24, 26 may include other application programs (e.g., 30a, 30b, 30c, 30d, etc.).

In one embodiment, application program 30 includes a math education, application 30a, pre-determined math education method 30b, an Artificial Intelligence (AI) application 30c and/or other application 30d. However, the present invention is not limited to such an embodiment and more, fewer and/or other applications can be used to practice the invention.

However, the protocol stack 38 is not limited to the protocol layers illustrated and more, fewer or other layers and protocols can also be used in protocol stack 38. In addition, other protocols from the Internet Protocol suites (e.g., Simple Mail Transfer Protocol, (SMTP), Hyper Text Transfer Protocol (HTTP), File Transfer Protocol (FTP), Dynamic Host Configuration Protocol (DHCP), DNS, etc.), Short Message Peer-to-Peer (SMPP), and/or other protocols from other protocol suites may also be used in protocol stack 38.

In addition, markup languages such as HyperText Markup Language (HTML), Extensible Markup Language (XML) and others are used.

HyperText Markup Language (HTML) is a markup language for creating web pages and other information that can be displayed in a web browser.

HTML is written in the form of HTML elements consisting of tags enclosed in angle brackets within the web page content. HTML tags most commonly come in pairs although some tags represent empty elements and so are unpaired. The first tag in a pair is the start tag, and the second tag is the end tag (they are also called opening tags and closing tags). In between these tags web designers can add text, further tags, comments and other types of text-based content.

The purpose of a web browser is to read HTML documents and compose them into visible or audible web pages. The browser does not display the HTML tags, but uses the tags to interpret the content of the page.

HTML elements form the building blocks of all websites. HTML allows images and objects to be embedded and can be used to create interactive forms. It provides a means to create structured documents by denoting structural semantics for text such as headings, paragraphs, lists, links, quotes and other items. It can embed scripts written in languages such as JavaScript which affect the behavior of HTML web pages.

Extensible Markup Language (XML) is another markup language that defines a set of rules for encoding documents in a format that is both human-readable and machine-readable. It is defined in the XML 1.0 Specification produced by the W3C, the contents of which are incorporated by reference and several other related specifications, all free open standards.

XML a textual data format with strong support via Unicode for the languages of the world. Although the design of XML focuses on documents, it is widely used for the representation of arbitrary data structures, for example in web services. The oldest schema language for XML is the Document Type Definition (DTD). DTDs within XML documents define entities, which are arbitrary fragments of text and/or markup tags that the XML processor inserts in the DTD itself and in the XML document wherever they are referenced, like character escapes.

The Short Message Peer-to-Peer (SMPP) protocol in the telecommunications industry is an open, industry standard protocol designed to provide a flexible data communication interface for the transfer of short message data between External Short Messaging Entities, Routing Entities (ESME) and Short Message Service Center (SMSC).

Preferred embodiments of the present invention include network devices and wired and wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum.

### Wireless Interfaces

In one embodiment of the present invention, the wireless interfaces on network devices 12, 14, 16, 20, 22, 24, 26, 31, 98-104 include but are not limited to, IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. However, the present invention is not limited to such an embodiment and other 802.11xx and other types of wireless interfaces can also be used.

802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

In one embodiment, the plural server network devices 20, 22, 24, 26 include a connection to plural network interface cards (NICs) in a backplane connected to a communications bus. The NIC cards provide gigabit/second (1×10⁹ bits/second) communications speed of electronic information. This allows “scaling out” for fast electronic content retrieval. The NICs are connected to the plural server network devices 20, 22, 24, 26 and the cloud communications network 18. However, the present invention is not limited to the NICs described and other types of NICs in other configurations and connections with and/or without buses can also be used to practice the invention.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 18 or non-cloud communications network 18′.

The one or more target network devices 12, 14, 16, 20, 22, 24, 26, 31, 98-104 and one or more server network devices 20, 22, 24, 26 communicate with each other and other network devices with near field communications (NFC) and/or machine-to-machine (M2M) communications.

“Near field communication (NFC)” is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags 99 and/or sensor.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

An “RFID tag” is an object that can be applied to or incorporated into a product, animal, or person for the purpose of identification and/or tracking using RF signals.

An “RFID sensor” is a device that measures a physical quantity and converts it into an RF signal which can be read by an observer or by an instrument (e.g., target network devices 12, 14, 16, 20, 22, 24, 26, 31, 98-104, server network devices 20, 22, 24, 26, etc.)

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modern M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

However, the present invention is not limited to such wireless interfaces and wireless networks and more, fewer and/or other wireless interfaces can be used to practice the invention.

### Wired Interfaces

In one embodiment of the present invention, the wired interfaces include wired interfaces and corresponding networking protocols for wired connections to the Public Switched Telephone Network (PSTN) and/or a cable television network (CATV) and/or satellite television networks (SATV) and/or three-dimensional television (3DTV), including HDTV that connect the network devices 12, 14, 16, 20, 22, 24, 26, 31, 98-104 via one or more twisted pairs of copper wires, digital subscriber lines (e.g. DSL, ADSL, VDSL, etc.) coaxial cable, fiber optic cable, other connection media or other connection interfaces. The PSTN is any public switched telephone network provided by AT&T, GTE, Sprint, MCI, SBC, Verizon and others. The CATV is any cable television network provided by the Comcast, Time Warner, etc. However, the present invention is not limited to such wired interfaces and more, fewer and/or other wired interfaces can be used to practice the invention.

### Television Services

In one embodiment, the cloud applications 30, 30a, 30c, 30b, 30c, 30d, 30e, 30f provide cloud SaaS 64 services and/or non-cloud application services from television services over the cloud communications network 18 or application services over the non-cloud communications network 18′. The television services include digital television services, including, but not limited to, cable television, satellite television, high-definition television, three-dimensional, televisions and other types of network devices.

However, the present invention is not limited to such television services and more, fewer and/or other television services can be used to practice the invention.

### Internet Television Services

In one embodiment, the cloud applications 30, 30a, 30c, 30b, 30c, 30d, 30e, 30f provide cloud SaaS 64 services and/or non-cloud application services from Internet television services over the cloud communications network 18 or non-cloud communications network 18′. The television services include Internet television, Web-TV, and/or Internet Protocol Television (IPtv) and/or other broadcast television services.

“Internet television” allows users to choose a program or the television show they want to watch from an archive of programs or from a channel directory. The two forms of viewing Internet television are streaming content directly to a media player or simply downloading a program to a viewer's set-top box, game console, computer, or other network device.

“Web-TV” delivers digital content via broadband and mobile networks. The digital content is streamed to a viewer's set-top box, game console, computer, or other network device.

“Internet Protocol television (IPtv)” is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats.

However, the present invention is not limited to such Internet Television services and more, fewer and/or other Internet Television services can be used to practice the invention.

### General Search Engine Services

In one embodiment, the cloud applications 30, 30a, 30c, 30b, 30c, 30d, 30e, 30f provide cloud SaaS 64 services and/or non-cloud application services from general search engine services. A search engine is designed to search for information on a cloud communications network 18 or non-cloud communications network 18′ such as the Internet including World Wide Web servers, HTTP, FTP servers etc. The search results are generally presented in a list of electronic results. The information may consist of web pages, images, electronic information, multimedia information, and other types of files. Some search engines also mine data available in databases or open directories. Unlike web directories, which are maintained by human editors, search engines typically operate algorithmically and/or are a mixture of algorithmic and human input.

In one embodiment, the cloud applications 30, 30a, 30c, 30b, 30c, 30d, 30e, 30f provide cloud SaaS 64 services and/or non-cloud application services from general search engine services. In another embodiment, the cloud applications 30, 30a, 30c, 30b, 30c, 30d, 30e, 30f provide general search engine services by interacting with one or more other public search engines (e.g., GOOGLE, BING, YAHOO, etc.) and/or private search engine services.

In another embodiment, the cloud applications 30, 30a, 30c, 30b, 30c, 30d, 30e, 30f provide cloud SaaS 64 services and/or non-cloud application services from specialized search engine services, such as vertical search engine services by interacting with one or more other public vertical search engines, and/or private search engine services.

However, the present invention is not limited to such general and/or vertical search engine services and more, fewer and/or other general search engine services can be used to practice the invention.

### Social Networking Services

In one embodiment, the cloud applications 30, 30a, 30c, 30b, 30c, 30d, 30e, 30f provide cloud SaaS 64 services and/or non-cloud application services from one more social networking services including to/from one or more social networking web-sites (e.g., FACEBOOK, YOUTUBE, TWITTER, INSTAGRAM, etc.). The social networking web-sites also include, but are not limited to, social couponing sites, dating web-sites, blogs, RSS feeds, and other types of information web-sites in which messages can be left or posted for a variety of social activities.

However, the present invention is not limited to the social networking services described and other public and private social networking services can also be used to practice the invention.

### Security and Encryption

Network devices 12, 14, 16, 20, 22, 24, 26, 31, 98-104 with wired and/or wireless interfaces of the present invention include one or more of the security and encryptions techniques discussed herein for secure communications on the cloud communications network 18 or non-cloud communications network 18′.

Application programs 58 (FIG. 2) include security and/or encryption application programs integral to and/or separate from the applications 30, 30a, 30c, 30b, 30c, 30d. Security and/or encryption programs may also exist in hardware components on the network devices (12, 14, 16, 20, 22, 24, 26, 31, 98-104) described herein and/or exist in a combination of hardware, software and/or firmware.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

RC4 is cipher designed by RSA Data Security, Inc. of Bedford, Massachusetts, which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i standard is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES).

DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired and incorporated herein by reference.

“Hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

Providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

An Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

The HyperText Transport Protocol (HTTP) Secure (HTTPS), is a standard for encrypted communications on the World Wide Web. HTTPs is actually just HTTP over a Secure Sockets Layer (SSL). For more information on HTTP, see IETF RFC-2616 incorporated herein by reference.

The SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security methods are negotiated between the source and destination at the start of establishing a protocol session. The SSL 2.0 protocol specification, by Kipp E. B. Hickman, 1995 is incorporated herein by reference. More information on SSL is available at the domain name See “netscape.com/eng/security/SSL_2.html.”

Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, California is supplier of networking hardware and software, including router and security products.

However, the present invention is not limited to such security and encryption methods described herein and more, fewer and/or other types of security and encryption methods can be used to practice the invention. The security and encryption methods described herein can also be used in various combinations and/or in different layers of the protocol stack 38 with each other.

### Cloud Computing Networks

FIG. 4 is a block diagram 60 illustrating an exemplary cloud computing network 18. The cloud computing network 18 is also referred to as a “cloud communications network” 18. However, the present invention is not limited to this cloud computing model and other cloud computing models can also be used to practice the invention. The exemplary cloud communications network includes both wired and/or wireless components of public and private networks.

In one embodiment, the cloud computing network 18 includes a cloud communications network 18 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Exemplary cloud computing essential characteristics appear in Table 1. However, the present invention is not limited to these essential characteristics and more, fewer or other characteristics can also be used to practice the invention.

TABLE 1
1. On-demand Math Education services. Automatic math education

services can unilaterally provision computing capabilities, such as
server time and network storage, as needed automatically without
requiring human interaction with each network server on the cloud
communications network 18.

2. Broadband network access. Automatic Math education services

capabilities are available over plural broadband communications
networks and accessed through standard mechanisms that promote
use by heterogeneous thin or thick client platforms (e.g., mobile
phones, smart phones 14, tablet computers 12, laptops, PDAs, etc.).
The broadband network access includes high speed network access
such as 3G, 4G and 5G wireless and/or wired and broadband and/or
ultra-broad band (e.g., WiMAX, etc.) network access.

3. Resource pooling. Automatic Math education services resources are

pooled to serve multiple requesters using a multi-tenant model,
with different physical and virtual resources dynamically assigned
and reassigned according to demand. There is location independence
in that a requester of services has no control and/ or knowledge over
the exact location of the provided by the Math education service
resources but may be able to specify location at a higher level of
abstraction (e.g., country, state, or data center). Examples of pooled
resources include storage, processing, memory, network bandwidth,
virtual server network device and virtual target network devices.

4. Rapid elasticity. Capabilities can be rapidly and elastically

provisioned, in some cases automatically, to quickly scale out and
rapidly released to quickly scale for Math education service
collaboration. For automatic Math education services, multi-media
collaboration converters, the automatic Math education services
collaboration and analytic conversion capabilities available for
provisioning appear to be unlimited and can be used in any quantity
at any time.

5. Measured Services. Cloud computing systems automatically control

and optimize resource use by leveraging a metering capability at
some level of abstraction appropriate to the type of automatic Math
education services (e.g., storage, processing, bandwidth, custom
electronic content retrieval applications, etc.). Electronic Automatic
Math education services collaboration conversion usage is
monitored, controlled, and reported providing transparency for both
the automatic Math educations services provider and the automatic
Math education service requester of the utilized electronic content
storage retrieval service.

Exemplary cloud computing service models illustrated in FIG. 4 appear in Table 2. However, the present invention is not limited to these service models and more, fewer or other service models can also be used to practice the invention.

TABLE 2
1. Cloud Computing Software Applications 62 for Math education

services (CCSA, SaaS 64). The capability to use the provider's
applications 30, 30a, 30c, 30b, 30c, 30d, 30e, 30f running on a cloud
infrastructure 66. The cloud computing applications 62, are
accessible from the server network device 20 from various client
devices 12, 14, 16 through a thin client interface such as a web
browser, etc. The user does not manage or control the underlying
cloud infrastructure 66 including network, servers, operating
systems, storage, or even individual application 30, 30a, 30c, 30b,
30c, 30d, 30e, 30f capabilities, with the possible exception of limited
user-specific application configuration settings.

2. Cloud Computing Infrastructure 66 for Math education services

(CCI 68). The capability provided to the user is to provision
processing, storage and retrieval, networks 18, 72, 74, 76, 78 and
other fundamental computing resources where the consumer is able
to deploy and run arbitrary software, which can include operating
systems and applications 30, 30a, 30c, 30b, 30c, 30d. The user does
not manage or control the underlying cloud infrastructure 66 but
has control over operating systems, storage, deployed applications,
and possibly limited control of select networking components (e.g.,
host firewalls, etc.).

3. Cloud Computing Platform 70 for Math education services (CCP

71). The capability provided to the user to deploy onto the cloud
infrastructure 66 created or acquired applications created using
programming languages and tools supported servers 20, 22, 24, 26,
etc .. The user not manage or control the underlying cloud
infrastructure 66 including network, servers, operating systems, or
storage, but has control over the deployed applications 30a, 30b,
30c, 30d, 30e, 30f and possibly application hosting environment
configurations.

Exemplary cloud computing deployment models appear in Table 3. However, the present invention is not limited to these deployment models and more, fewer or other deployment models can also be used to practice the invention.

TABLE 3
1. Private cloud network 72. The cloud network infrastructure is

operated solely for Math education services. It may be managed by
the electronic content retrieval or a third party and may exist on
premise or off premise.

2. Community cloud network 74. The cloud network infrastructure is

shared by several different organizations and supports a specific
electronic content storage and retrieval community that has shared
concerns (e.g., mission, security requirements, policy, compliance
considerations, etc.). It may be managed by the different
organizations or a third party and may exist on premise or off
premise.

3. Public cloud network 76. The cloud network infrastructure such as

the Internet, PSTN, SATV, CATV, Internet TV, etc. is made
available to the general public or a large industry group and is
owned by one or more organizations selling cloud services.

4. Hybrid cloud network 78. The cloud network infrastructure 66 is a

composition of two and/or more cloud networks 18 (e.g., private 72,
community 74, and/or public 76, etc.) and/or other types of public
and/or private networks (e.g., intranets, etc.) that remain unique
entities but are bound together by standardized or proprietary
technology that enables data and application portability (e.g., cloud
bursting for load-balancing between clouds, etc.)

Cloud software 64 for electronic content retrieval takes full advantage of the cloud paradigm by being service oriented with a focus on statelessness, low coupling, modularity, and semantic interoperability for electronic content retrieval. However, cloud software services 64 can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the cloud application 30, 30a, 30c, 30b, 30c, 30d, offers cloud services for math education. The application 30, 30a, 30c, 30b, 30c, 30d, 30e, 30f offers the cloud computing Infrastructure 66, 68 as a Service 62 (IaaS), including a cloud software infrastructure service 62, the cloud Platform 70, 71 as a Service 62 (PaaS) including a cloud software platform service 62 and/or offers Specific cloud software services as a Service 64 (SaaS) including a specific cloud software service 64 for Math education services. The IaaS, PaaS and SaaS include one or more of cloud services 62 comprising networking, storage, server network device, virtualization, operating system, middleware, run-time, data and/or application services, or plural combinations thereof, on the cloud communications network 18.

FIG. 5 is a block diagram 80 illustrating an exemplary cloud storage object 82. One or more server network devices (e.g., 20, 22, 24, 26, etc.) store portions 13′, 15′ of the electronic message content 13, 15 (e.g., SMS, MMS, RCS, etc.) for math education as cloud storage objects 82 (FIG. 5) as is described herein.

The cloud storage object 82 includes an envelope portion 84, with a header portion 86, and a body portion 88. However, the present invention is not limited to such a cloud storage object 82 and other cloud storage objects and other cloud storage objects with more, fewer or other portions can also be used to practice the invention.

The envelope portion 84 uses unique namespace Uniform Resource Identifiers (URIs) and/or Uniform Resource Names (URNs), and/or Uniform Resource Locators (URLs) unique across the cloud communications network 18 to uniquely specify, location and version information and encoding rules used by the cloud storage object 82 across the whole cloud communications network 18. For more information, see IETF RFC-3305, Uniform Resource Identifiers (URIs), URLs, and Uniform Resource Names (URNs), the contents of which are incorporated by reference.

The envelope portion 84 of the cloud storage object 82 is followed by a header portion 86. The header portion 86 includes extended information about the cloud storage objects such as authorization and/or transaction information, etc.

The body portion 88 includes methods 90 (i.e., a sequence of instructions, etc.) for using embedded application-specific data in data elements 92. The body portion 88 typically includes only one portion of plural portions of application-specific data 92 and independent data 94 so the cloud storage object 82 can provide distributed, redundant fault tolerant, security and privacy features described herein.

Cloud storage objects 82 have proven experimentally to be a highly scalable, available and reliable layer of abstraction that also minimizes the limitations of common file systems. Cloud storage objects 82 also provide low latency and low storage and transmission costs.

Cloud storage objects 82 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 18. Cloud storage objects 82 are also highly durable because of creation of copies of portions of desired electronic content across such networks 72, 74, 76, 78 of the cloud communications network 18. Cloud storage objects 82 includes one or more portions of desired electronic content and can be stored on any of the 72, 74, 76, 78 networks of the cloud communications network 18. Cloud storage objects 82 are transparent to a requester of desired electronic content and are managed by cloud applications 30, 30a, 30c, 30b, 30c, 30d.

In one embodiment, cloud storage objects 82 are configurable arbitrary objects with a size up to hundreds of terabytes, each accompanied by with a few kilobytes of metadata. Cloud objects are organized into and identified by a unique identifier unique across the whole cloud communications network 18. However, the present invention is not limited to the cloud storage objects described, and more fewer and other types of cloud storage objects can be used to practice the invention.

Cloud storage objects 82 present a single unified namespace or object-space and manages desired electronic content by user or administrator-defined policies storage and retrieval policies. Cloud storage objects includes Representational state transfer (REST), Simple Object Access Protocol (SOAP), Lightweight Directory Access Protocol (LDAP) and/or Application Programming Interface (API) objects and/or other types of cloud storage objects. However, the present invention is not limited to the cloud storage objects described, and more fewer and other types of cloud storage objects can be used to practice the invention.

REST is a protocol specification that characterizes and constrains macro-interactions storage objects of the four components of a cloud communications network 18, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.)

LDAP is a software protocol for enabling storage and retrieval of electronic content and other resources such as files and devices on the cloud communications network 18. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction and provides access to automatic Math education services in a cloud or non-cloud environment. In one embodiment, the API for Math education services is available to network devices 12, 14, 16, 20, 22, 24, 26, 31, 98-104 and networks 18, 18′. However, the present invention is not limited to such an embodiment and other embodiments can be used to practice the invention.

### Wearable Devices

Wearable technology” and/or “wearable devices” are clothing and accessories incorporating computer and advanced electronic technologies. Wearable network devices provide several advantages including, but not limited to: (1) Quicker access to notifications. Important and/or summary notifications are sent to alert a user to view the whole message. (2) Heads-up information. Digital eye wear allows users to display relevant information like directions without having to constantly glance down; (3) Always-on Searches. Wearable devices provide always-on, hands-free searches; and (4) Recorded data and feedback. Wearable devices take telemetric data recordings and providing useful feedback for users for exercise, health, fitness, etc. activities.

FIG. 6 is a block diagram with 96 illustrating wearable devices. The wearable devices include one or more processors and include, but are not limited to, wearable digital glasses 98, clothing 100, jewelry 102 (e.g., smart rings, smart earrings, etc.) and/or watches 104. However, the present invention is not limited to such embodiments and more, fewer and other types of wearable devices can also be used to practice the invention.

In one specific embodiment, the application 30, 30a, 30c, 30b, 30c, 30d, 30e, 30f interacts with wearable devices 98-104 automatic Math education services the methods described herein. However, the present invention is not limited this embodiment and other embodiments can also be used to practice the invention.

### Artificial Intelligence (AI) and Big Data

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points.

In one embodiment, the present invention uses one or more AI methods including, but are not limited to, AI knowledge-based methods 30c for Math education services. The math education services, include but are not limited to, teaching math operations, including, but not limited to, addition, subtraction, multiplication, division, math operation precedence rules, etc., recording results and presenting a user with math operations that need the most work based on previous iterations using one or more different types of statistical methods.

In one embodiment, the Artificial Intelligence (AI) based methods 30c includes, but are not limited to: (1) an AI random number generator method to generate random numbers to simulate rolling of all dice 108, 122-128, 130, 144 using data structures one to five; (2) an AI difficulty method to increase a difficulty and reduce a difficulty of the math operations presented addition 110, subtraction 112, multiplication 114 and division 116 on the specialized math education graphical dice 108; and (3) an AI combination method for automatically determining a number of possible combinations of operations 110-116 for each simulated roll of the four numbers dice 122-128. However, the present invention is not limited to such an embodiment and more, fewer and/or other AI methods can be used to practice the invention.

In one embodiment, the Artificial Intelligence (AI) based methods 30c includes, but are not limited to: (1) an AI method determining a grade level for math education; (2) an AI method for automatically adjusting a difficulty level for the math education based on the determined grade level; (3) an AI method for automatically adjusting numeric values for a number of emojis in the first data structure and the second data structure; (4) an AI method for providing dynamic and different outcomes based on probabilities and possibilities of different dice faces occurring when rolled; and (5) an AI method recording and tracking math operation results and game outcomes. However, the present invention is not limited to such an embodiment and more, fewer and/or other AI methods can be used to practice the invention.

An emoji, includes, but is not limited to, a graphical symbol, graphical text, pictogram, logogram and/or ideogram. However, the present invention is not limited to such an embodiment and other embodiments may be used to practice the invention.

In one embodiment, SaaS 64 includes and AI application 30c with the AI methods described herein. In another embodiment, the AI application 30c is a standalone application. However, the present invention is not limited to such an embodiment, and the AI application 30c can be provided in other than the SaaS 64.

“Big Data” refers to the use of predictive analytic methods that extract value from data, and to a particular size of data set. The quantities of data used are very large, at least 100,000 data points and more typically 500,000 to 1 Million+ data points. Analysis of Big Data sets are used to find new correlations and to spot trends. In one embodiment, SaaS 64 includes and Big Data application 30d with the Big Data described herein.

In one embodiment, the AI methods described herein collect data information to create and store (e.g., in cloud storage object 82, etc.) a Big Data that is used to analyze trends find new correlations and to spot trends. However, the present invention is not limited to such an embodiment and the AI methods described herein can be used without Big Data sets.

### Short Message Service (SMS) Messaging

Short Message Service (SMS) is an electronic text messaging service component of phone, Web, or mobile communication systems. It uses standardized communications protocols to allow fixed line or mobile phone devices to exchange short text messages.

SMS messages were defined in 1985 as part of the Global System for Mobile Communications (GSM) series of standards as a means of sending messages of up to 160 characters to and from GSM mobile handsets. Though most SMS messages are mobile-to-mobile text messages, support for the service has expanded to include other mobile technologies as well as satellite and landline networks.

The SMS Internet Engineering Task Force (IETF) Request for Comments (RFC) 5724, ISSN: 2070-1721, 2010, is incorporated herein by reference.

### Direct and Instant Messages

A “direct message” (DM) is a private form of communication between social media users that is only visible to the sender and recipient(s). INSTAGRAM, TWITTER, FACEBOOK and other platforms, allow for direct messages between their users, with varying restrictions by platform.

An “instant message” (IM) is a type of online chat allowing real-time text transmission over the Internet or another computer network. Messages are typically transmitted between two or more parties, when each user inputs text and triggers a transmission to the recipient, who are all connected on a common network.

### Multimedia Messaging Service (MMS)

Multimedia Messaging Service (MMS) is a standard way to send messages that include multimedia content to and from a mobile phone over a cellular network. Users and providers may refer to such a message as a PXT, a picture message, and/or a multimedia message.

The MMS Internet Engineering Task Force (IETF) Request for Comments (RFC) 4355 and 4356, are incorporated herein by reference.

### Rich Communication Suite (RCS)

Rich Communications Suite/Rich Communications System (RCS) is a communication protocol between mobile telephone carriers, between phones and carriers, and between individual devices aiming at replacing SMS messages with a message system that is richer, provides phonebook polling (e.g., for service discovery, etc.), and can transmit in-call multimedia. It is also marketed under the names of Advanced Messaging, Advanced Communications, Chat, joyn, Message+ and SMS+. RCS is also a communication protocol available for device-to-device (D2D) exchanges without using a telecommunications carrier for devices that are in close physical proximity (e.g., between two IoT devices, smart phones, smart phone and electronic tablet, etc.)

One advantage RCS Messaging has over SMS is that RCS enables users to send rich, verified messages including photos, videos and audio messages, group messages, read receipts, indicators to show other users are typing a message, carousel messages, suggested chips, chat bots, barcodes, location integration, calendar integration, dialer integration, and other RCS messaging features. RCS messaging includes person-to-person (P2P), application-to-person (A2P), application-to-application (A2A), application-to-device (A2D) and/or device-to-device (D2D) messaging.

The RCS Interworking Guidelines Version 14.0, 13 Oct. 2017, GSM Association, Rich Communication Suite RCS API Detailed Requirements, version 3.0, Oct. 19, 2017, Rich Communication Suite 8.0 Advanced Communications Services and Client Specification Version 9.0, 16 May 2018, RCS Universal Profile Service Definition Document Version 2.2, 16 May 2018, and Rich Communication Suite Endorsement of OMA CPM 2.2 Conversation Functions Version 9.0, 16 Oct. 2019, are all incorporated herein by reference.

The Rich Communication Suite-Enhanced (RCS-e) includes methods of providing first stage interoperability among Mobile Network Operators (MNOs). RCS-e is a later version of RCS which enables mobile phone end users to use instant messaging (IM), live video sharing and file transfer across any device on any MNO.

The RCS functionality of the present invention includes, but is not limited to, one and two way, rich, verified, multimedia messages including photos, videos and audio messages, group messages, read receipts, indicators to show other users are typing a message, predefined quick-reply suggestions, rich cards, carousels, action buttons, maps, click-to-call, calendar integration, geo-location, etc. The RCS functionality also includes RCS emulators and/or thin RCS applications that provide full and/or selected features of available RCS functionality. The Math education application 30a provides full and/or partial RCS functionality.

The RCS functionality of the present invention also includes selected portions of math education used in the Math education application 30a. However, the present invention is not limited to such embodiments.

### Math Education

In one embodiment, math education is achieved in the scope of a game using plural dice and a set of math game rules. However, the present invention is not limited to this embodiment and other embodiments can be used to practice the invention.

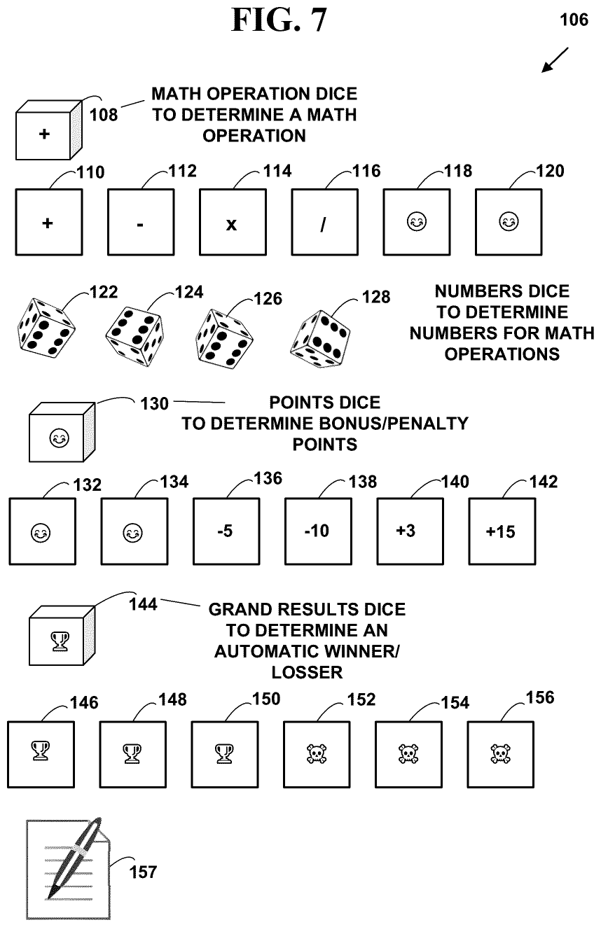

FIG. 7 is a block diagram 106 illustrating plural dice used for math education.

FIG. 7 illustrates a math operation dice 108 as a six-sided cube with individual faces including an addition operation 110, a subtraction operation 112, a multiplication operation 114, a division operation 116, and two emjois 118, 120 to active a roll of a determination dice 130, on the six individual faces of the math operation dice 108. However, the present invention is not limited to such embodiments and other embodiments can be used to practice the invention and the emjois can be replaced with graphical icons and/other types of graphical symbols.

FIG. 7 further illustrates four dice 122, 124, 126, 128 as six-sided cubes, each with the numbers one through six, with one number on each face of the six-sided cubes. However, the present invention is not limited to four dice and more dice (e.g., more advanced math education) and/or fewer dice (e.g., simpler math education, etc.) can be used to practice the invention.

When a roll of the math operation dice 108 lands on an emoji 118, 120, a roll of the determination dice 130 is activated. The determination dice 130 assigns penalty points and activates a grand result dice 144 that provides an automatic win or loss of the game with a roll of the grand result dice.

FIG. 7 further illustrates a determination dice 130 as a six-sided cube with individual faces including one or more emojis 132, 134 to activate a grand result dice 144, penalty point numbers 136, 138 (illustrated as-5,-10 etc.) and bonus point numbers 140, 142 (illustrated as +3 and +15 etc.) as the six individual faces of the math operation dice 108. FIG. 7 illustrates more penalty points than bonus points. However, the present invention is not limited to this embodiment and this specific number of penalty points (e.g., four) and bonus point numbers (e.g., one) and more or fewer bonus point numbers and penalty point numbers and other specific amounts for the penalty points and bonus points can be used to practice the invention.

FIG. 7 further illustrates the grand results dice 144 as a six-sided cube with individual faces including two different emojis to allow an automatic win or loss of the game when the grand results dice 144 is rolled. FIG. 7 illustrates an equal number of winning emojis 146-150 (e.g., a graphical trophy) and losing emojis 152-156 (e.g., a skull and cross bones). However, the present invention is not limited to this embodiment and other emojis and other embodiments with other numbers of winning emojis and losing emojis can be used to be practice the invention.

FIG. 7 further illustrates a points total summary sheet 157 that is used if the dice 108, 122-128, 130, 144 are physical objects. However, the present invention is not limited to such an embodiment and the points total summary sheet 157 can also include a virtual object of the dice 108, 122-128, 130, 144 are virtual objects generated by an application 30, 30a, 30c, SaaS 64 on a network device 12, 14, 16, 20, 22, 24, 26, 31, 98-104

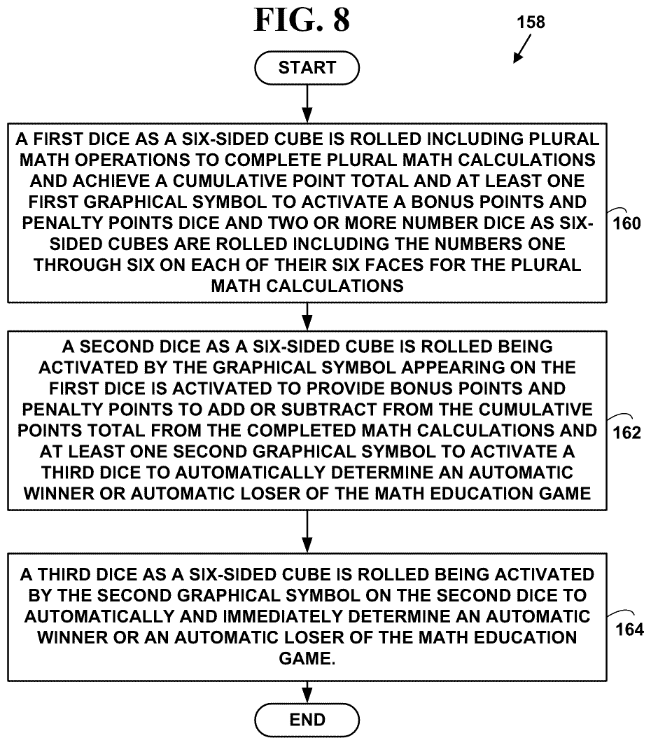

FIG. 8 is a flow diagram illustrating a Method 158 for math education with a dice game.

In FIG. 8 at Step 160, a first dice as a six-sided cube is rolled including plural math operations to complete plural math calculations and achieve a cumulative point total and at least one first graphical symbol to activate a bonus points and penalty points dice and two or more number dice as six-sided cubes are rolled including the numbers one through six on each of their six faces for the plural math calculations. At Step 162, a second dice as a six-sided cube is rolled being activated by the graphical symbol appearing on the first dice is activated to provide bonus points and penalty points to add or subtract from the cumulative points total from the completed math calculations and at least one second graphical symbol to activate a third dice to automatically determine an automatic winner or automatic loser of a math education dice game. At Step 164, a third dice as a six-sided cube is rolled being activated by the second graphical symbol on the second dice to automatically and immediately determine an automatic winner or an automatic loser of the math education dice game.

Method 158 is described with an illustrative embodiment. However, the present invention is not limited to such an embodiment and other embodiments can be used to practice the invention.

In such an illustrative embodiment at FIG. 8 at Step 160, In FIG. 8 at Step 160, a first dice 108 as a six-sided cube is rolled including plural math operations 110-116 to complete plural math calculations and achieve a cumulative point total and at least one first graphical symbol 118, 120 to activate a bonus points and penalty points dice and two or more number dice (122-128) as six-sided cubes are rolled including the numbers one through six on each of their six faces for the plural math calculations.

At Step 162, a second dice 130 as a six-sided cube is rolled being activated by the graphical symbol 118, 120 appearing on the first dice 108 is activated to provide bonus points 142 and penalty points 134-140 to add or subtract from the cumulative points total from the completed math calculations and at least one second graphical symbol 132 to activate a third dice 144 to automatically determine an automatic winner or automatic loser of a math education dice game.

At Step 164, a third dice as a six-sided cube 144 is rolled being activated by the second graphical symbol 132 on the second dice 130 to automatically and immediately determine an automatic winner 146-150 or an automatic loser 152-156 of the math education dice game.

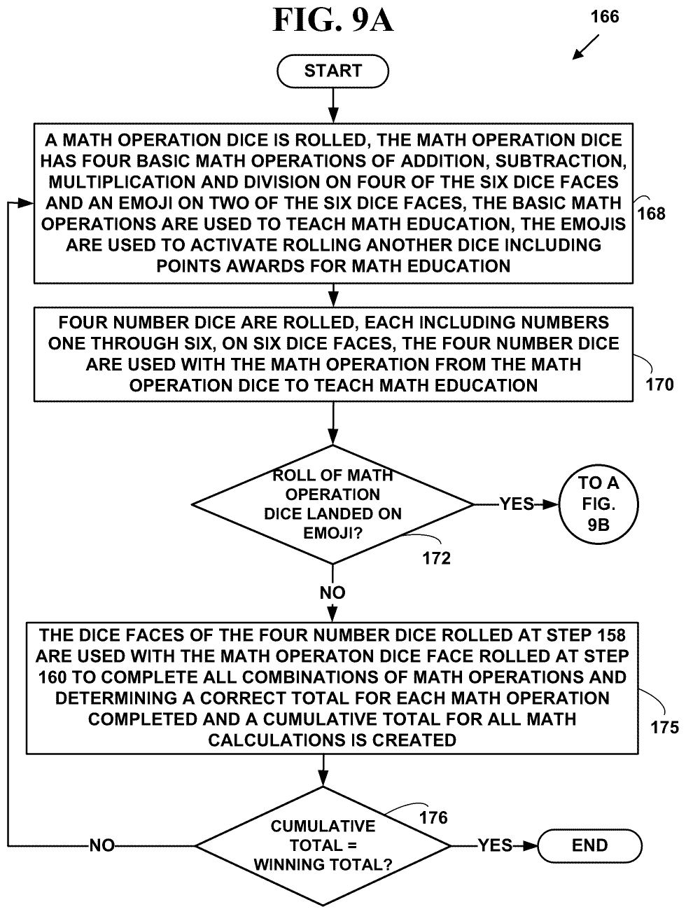

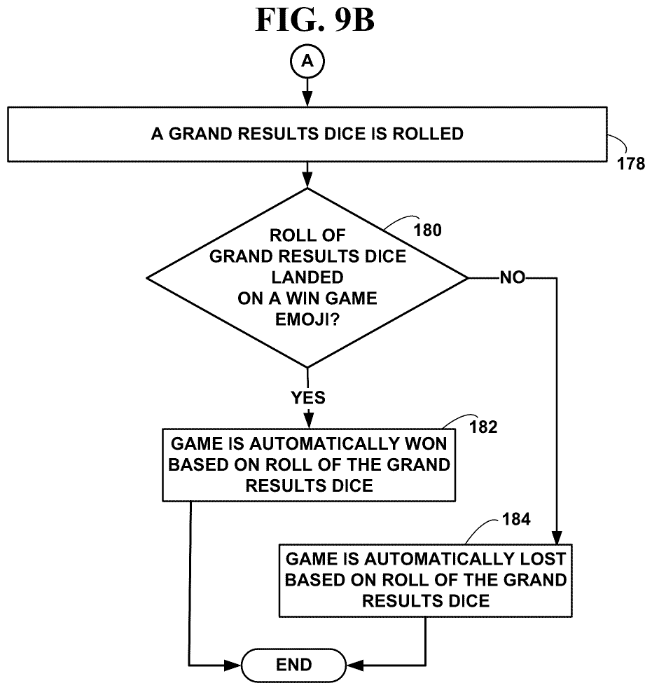

FIGS. 9A and 9B are a flow diagram illustrating a Method 166 for math education with a dice game.

In FIG. 9A at Step 168, a math dice is rolled. The math dice has four basic math operations of addition, subtraction, multiplication and division on four of the six dice faces and an emoji on two of the six dice faces. The basic math operations are used to teach math education. The emojis are used to activate rolling another dice including points awards for math education. At Step 170, four number dice are rolled, each including numbers one through six, on six dice faces. The number dice are used with the math operation from the math dice to teach math education for the math operation rolled. At Step 172, a test is conducted to determine if the math operation dice rolled at Step 168 landed on a dice face with an emoji. If at Step 172, the math operation dice rolled at Step 168 did not land on a dice face with an emoji, then at Step 164, the dice faces of the four number dice rolled at Step 170 are used with the math operation dice face rolled at Step 168 to complete combinations of math operations and determining a correct total for each math operation completed and a cumulative total for all math calculations. At Step 176, a test is conducted to determine if the cumulative total for all math calculations is equal to a winning total. If the test is conducted at Step 166 determines cumulative total for all math calculations is equal to a winning total (e.g., 200 points, etc.) then the game ends. If the test is conducted at Step 176 determines cumulative total for all math calculations is not equal to a winning total, the Steps 168-176 are repeated (e.g., with a second player, third player, etc.) until a winning total is achieved or an emoji is rolled with math operation dice. If at Step 172, the math operation dice rolled at Step 168 did land on a dice face with an emoji, then in FIG. 9B at step 178, a roll of a grand results dice is activated to automatically determine a winner of the game or a loser of the game. At Step 180, a test is conducted to determine if the roll of the grand results dice indicates an automatic win of the game. If the test at Step 180 determines the roll of the grand results dice indicates an automatic winner of the game, then at Step 182, the roller of the grand results dice is declared the automatic winner of the game and the game ends. If the test at Step 180 determines the roll of the grand results dice does not indicate an automatic winner of the game, then at Step 184, the roller of the grand results game is declared the automatic loser of the game and the game is over.

Method 166 is described with an illustrative embodiment. However, the present invention is not limited to such an embodiment and other embodiments can be used to practice the invention.

In such an illustrative embodiment in FIG. 9A at Step 168, a math operation dice 108 is rolled. The math operation dice 108 has four basic math operations of addition 110, subtraction 112, multiplication 114 and division 116 on four of the six dice faces and an emoji 118, 120 on two of the six dice faces. The basic math operations are used to teach math education. The emojis are used to activate rolling another dice including points awards for math education. FIG. 7 illustrates a math operation dice 108 with two identical emojis 118, 120. However, the present invention is not limited to such an embodiment and two different emojis an also be used to practice the invention.

At Step 170, four number dice 122-128 are rolled, each including numbers one through six, on six dice faces. The number dice 122-128 are used with the math operation 114-120 from the math operation dice 108 to teach math education for that math operation.

At Step 172, a test is conducted to determine if the math operation dice 108 rolled at Step 168 landed on a dice face with an emoji 118, 120. If at Step 162, the math operation dice 108 rolled at Step 158 did not land on a dice face with an emoji 118, 120, then at Step 174, the dice faces of the four number dice 122-128 rolled at Step 168 are used with the math operation dice 108 face 110-116 rolled at Step 168 to complete combinations of math operations and determining a correct total for each math operation completed and a cumulative total for all math calculations.

For example, if the math operation dice rolled at Step 168 landed on addition 110 and the four dice 122-128 rolled at Step 170 included the numbers 6, 4, 3, 2, then at Step 162, the math operation of addition 110 would be applied as (6+4=10, 6+3=9, 6+2=8; 4+6=10, 4+3=7, 4+2-6; 2+6=8, 2+4=6; 2+3=5), with a cumulative total of (10+9+8+10+7+6+8+6+5=69) for this roll. That is 6 gets added to a set with (4, 3, 2), 4 gets added to a set with (6, 3, 2), 3 gets added to a set with (6, 4, 2) and 2 gets added to a set with (6, 4, 3). In this example, an addition operation 110 is not applied directly to a number itself (e.g., 6+6, etc.). However, the present invention is not limited to such an embodiment and the numbers from the dice 122-128 can have math operations 110-116 applied directly to themselves as well.

If the math dice rolled at Step 168 landed on subtraction 112 rolled at Step 170 included the numbers 6, 4, 3, 2, then at Step 162, the math operation of subtraction 112 would be applied as (6−4=2, 6−3=3, 6−2=4, 4−3=1, 4−2=2, 3−2=1 (assuming only positive numbers are used) with a cumulative total of (2+3+4+1+2+1=13) for this roll or a cumulative total of −1 (13+−14=−1) if negative numbers (4−6=−2, 3−6=−3, 3−4=−1, 2−6=−4, 2−4=−2; 2−3=−1=−14) are allowed. In this example, a subtraction operation 112 is not applied directly to a number itself (e.g., 6-6, etc.). However, the present invention is not limited to such an embodiment and the numbers from the dice 122-128 can have math operations 110-116 applied directly to themselves as well.

If the math dice rolled at Step 168 landed on multiplication 114 rolled at Step 170 included the numbers 6, 4, 3, 2, then at Step 162, the math operation of multiplication 114 would be applied as (6×4=24, 6×3=18, 6×2=12, 4×6=24, 4×3=12, 4×2=8, 2×3=6, 2×4=8, 2×6=12) with a cumulative total of (24+18+12+24+12+8+6+8+12=124) for this roll. In this example, a multiplication 114 not applied directly to a number itself (e.g., 6×6, etc.). However, the present invention is not limited to such an embodiment and the numbers from the dice 122-128 can have math operations 110-116 applied directly to themselves as well.

If the math dice rolled at Step 168 landed on division 116 rolled at Step 170 included the numbers 6, 4, 3, 2, then at Step 162, the math operation of division 116 would be applied as (6/3=2, 6/2=3, 4/2=2) assuming only positive numbers are used with only division with no remainers allowed (e.g. 6/4, etc.) with no factions allowed (i.e., without fractions generated with 2/3, 2/4, 2/6, etc.) with a cumulative total of (2+3+2=7) for this roll. However, the invention is not limited to this embodiment and other embodiments with other rules for negative numbers, fractions, division with and without remainders, can be used to practice the invention. In this example, a division operation 116 not applied directly to a number itself (e.g., 6/6, etc.). However, the present invention is not limited to such an embodiment and the numbers from the dice 122-128 can have math operations 110-116 applied directly to themselves as well.

In addition, the examples just discuss did not include apply a math operation on a number of a face of a dice 122-128 directly to itself. For example, the addition of 6+6=12, 4+4=8, 3+3-6 and 2+2=4 was not included in the addition 110 calculations. However, in another embodiment of this invention, such additional calculations applying a number on a face of a dice 122-128 rolled can be used to practice the invention.

Such variations of applying or not applying a number to itself with a math operation also teach an additional math concept of set theory. Set theory is used to analyze sets with well-determined collections of objects (e.g., numbers, etc.) that are completely characterized by their elements. Thus, two sets are equal if and only if they have exactly the same elements. The basic relation in set theory is that of element membership. However, the present invention is not limited to such an embodiment and other embodiments can be used to practice the invention with and/or without the use of set theory.

In another embodiment, one of the emojis 118, 120 can be replaced with a parentheses symbol “)” to allow a roller practice order and precedence of math operations. In another embodiment, one of the emojis 118, 120 can be replaced with a second math operation 112-116 to help ensure a roller will get additional practice practicing math. However, the present invention is not limited to such an embodiment and other embodiments can be used to practice the invention.

Returning to FIG. 9A, If at Step 172, the math operation dice 108 rolled at Step 168 did land on a dice face with an emoji 118, 120, then in FIG. 9B at step 178, a roll of a grand results dice 144 is activated to automatically determine an automatic winner of the game or a loser of the game.

At Step 180 a test is conducted to determine if the roll of the grand results dice 144 indicates an automatic winner of a math education dice game.

If the test at Step 180 determines the roll of the grand results dice 144 indicates an automatic win of the math education dice game, then as Step 172 the roller of the grand results dice 144 is declared the winner of the math education dice game and the math education dice game ends.

If the test at Step 170 determines the roll of the grand results dice 144 does not indicate an automatic winner of the game, then at Step 174, the roller of the grand results dice 144 is declared an automatic loser of the math education dice game and the math education dice game is over.

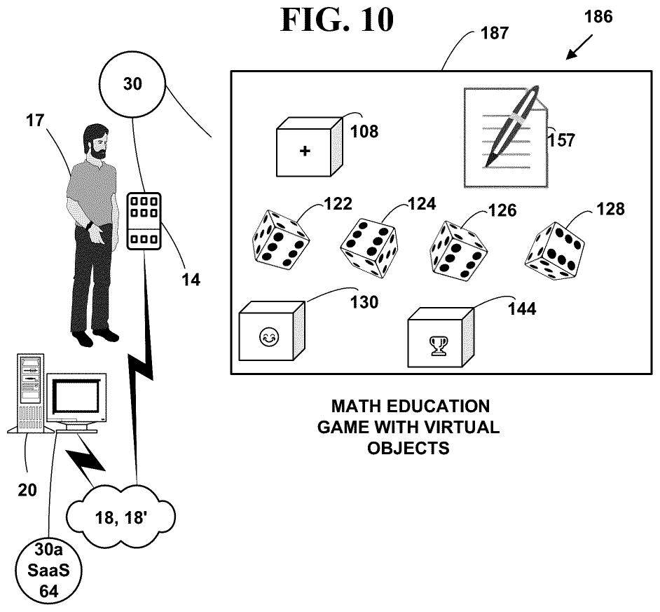

FIG. 10 is a block diagram 166 illustrating a virtual implementation of math education with a dice game.

In one embodiment as is illustrated in FIG. 10, Methods 158 and/or 160 are implemented on a software application 30 directly on the one or more target devices 12, 14, 16, 31, 98-104. In another embodiment, Methods 158 and/or 160 are implemented on a software application 30a, 30b, 30c and/or as a cloud SaaS 64 on a server network device 20, 22, 24, 26 in communications with a software application 30 on the one or more target devices 12, 14, 16, 31, 98-104 via a communications network 18′. In another embodiment, the one or more target devices 12, 14, 16, 31, 98-104 on a cloud communications network 18. In such embodiments the dice 108, 122-128, 130, 144 are virtual objects and the plural math calculations, the cumulative point totals and winning point totals are computed automatically by the applications 30, 30a, 30c, SaaS 64. In such embodiments, the points total summary sheet 157 is included as a virtual object. In such embodiments, FIG. 10 includes a virtual math education dice game 187.

However, the present invention is not limited to such embodiments and other embodiments can be used to practice the invention including combination of cloud and non-cloud applications and/or combinations or target network device and/or server network devices.

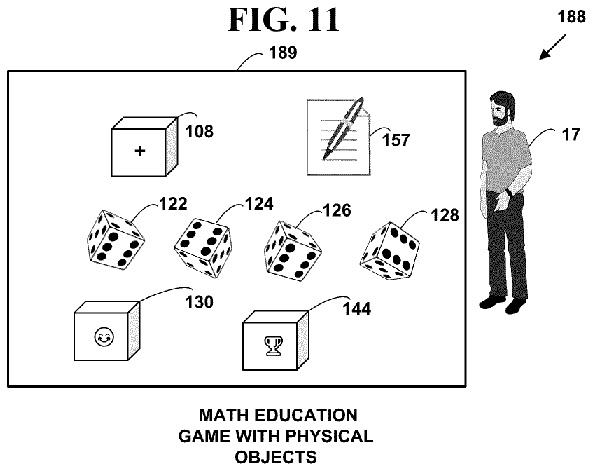

FIG. 11 is a block diagram 188 illustrating a physical implementation of math education with a dice game.

In another embodiment, as is illustrated in FIG. 11, the dice 108, 122-128, 130, 144 and the points total summary sheet 157 are physical objects, including but not limited to, wood, paper, plastic, metal and/or composite materials. In such an embodiment, the plural math calculations, the cumulative point totals and winning point totals are computed manually. In such an embodiment, a math education dice game points total sheet 157 is included as a paper object. The dice 108, 122-128, 130, 144 and the points total summary sheet 157 are physical objects comprising a physical math education dice game 189.

In such an embodiment, the dice 108, 122-128, 130, 144 are physical objects that are injection molded, extruded, pultruded, pull-winded, 3D-printed and/or manufactured and/or produced with other techniques using one or more the materials described herein. However, the present invention is not limited to such an embodiment and more, fewer or other types manufacturing techniques can be used to practice the invention.

“Injection molding” is a manufacturing process for producing parts by injecting molten material into a mold. Injection molding can be performed with a host of materials mainly including metals (for which the process is called die-casting), glasses, elastomers, confections and most commonly thermoplastic and thermosetting polymers.

Material for an injection molded part is fed into a heated barrel, mixed (e.g., using a helical shaped screw, etc.), and injected into a mold cavity, where it cools and hardens to the configuration of the cavity. After a product is designed, usually by an industrial designer or an engineer, molds are made by a mold-maker (or toolmaker) from metal, usually either steel or aluminum, and precision machined to form the features of the desired part. Injection molding is widely used for manufacturing a variety of parts, from the smallest components to entire body panels of cars. Advances in 3D printing technology, using photopolymers that do not melt during the injection molding of some lower temperature thermoplastics, can be used for some simple injection molds.

“Extrusion” is a manufacturing process where a material is pushed and/or drawn through a die to create long objects of a fixed cross-section. Hollow sections are usually extruded by placing a pin or mandrel in the die. Extrusion may be continuous (e.g., producing indefinitely long materials, etc.) or semi-continuous (e.g., repeatedly producing many shorter pieces). Some extruded materials are hot drawn and others may be cold drawn.

The feedstock may be forced through the die by various methods: by an auger, which can be single or twin screw, powered by an electric motor; by a ram, driven by hydraulic pressure, oil pressure or in other specialized processes such as rollers inside a perforated drum for the production of many simultaneous streams of material.

In one embodiment, the dice 108, 122-128, 130, 144 comprise extruded plastic materials including, but not limited to, Polyvinyl Chloride (PVC), Acrylonitrile Butadiene Styrene (ABS), High Impact Polypropylene (HIP), Polypropylene, High-Density Polyethylene (HDPE), Polycarbonate, Polyethylene Terephthalate Glycol (PETG), Nylon, Fiber reinforced Polypropylene, Fiber Reinforced Plystyrene and other types of plastics. In another embodiment, the dice 108, 122-128, 130, 144 comprises composite materials. In another embodiment, the dice 108, 122-128, 130, 144 comprises recycled plastic materials. However, the present invention is not limited to such embodiments and other embodiments can also be used to practice the invention.

Plastic extrusion commonly uses plastic chips, which are heated and extruded in the liquid state, then cooled and solidified as it passes through the die. In some cases (such as fiber reinforced tubes) the extrudate is pulled through a very long die, in a process called “pultrusion.” However, the present invention is not limited to such embodiments and other embodiments can also be used to practice the invention.

“Pultrusion” is a manufacturing process for producing continuous lengths of materials. Pultrusion raw materials include a liquid resin mixture (e.g., containing resin, fillers and specialized additives) and reinforcing fibers (e.g., fiberglass, composite materials, etc.). The process involves pulling these raw materials (rather than pushing as is the case in extrusion) through a heated steel forming die using a continuous pulling device. The reinforcement materials are in continuous forms such as rolls of fiberglass mat or doffs of fiberglass roving. As the reinforcements are saturated with the resin mixture in the resin impregnator and pulled through the die, the gelation (or hardening) of the resin is initiated by the heat from the die and a rigid, cured profile is formed that corresponds to the shape of the die.

Protruded laminates are also used. Most pultruded laminates are formed using rovings aligned down the major axis of the part. Various continuous strand mats, fabrics (e.g., braided, woven and knitted), and texturized or bulked rovings are used to obtain strength in the cross axis or transverse direction. However, the present invention is not limited to such embodiments and other embodiments can also be used to practice the invention.

The pultrusion process is normally continuous and highly automated. Reinforcement materials, such as roving, mat or fabrics, are positioned in a specific location using preforming shapers or guides to form a pultruson. The reinforcements are drawn through a resin bath where the material is thoroughly coated or impregnated with a liquid thermosetting resin. The resin-saturated reinforcements enter a heated metal pultrusion die. The dimensions and shape of the die define the finished part being fabricated. Inside the metal die, heat is transferred initiated by precise temperature control to the reinforcements and liquid resin. The heat energy activates the curing or polymerization of thermoset resin changing it from a liquid to a solid. The solid laminate emerges from the pultrusion die to the exact shape of the die cavity. The laminate solidifies when cooled and it is continuously pulled through the pultrusion machine and cut to the desired length. The process is driven by a system of caterpillar or tandem pullers located between the die exit and the cut-off mechanism.

In one embodiment, the pultrusion resins include bisphenol-a epichlorohydrin-based vinyl esters. In another embodiment, the resins include polyesters including isophthalic, orthophthalic, propylene-maleate, fire resistant, and high cross-link density. However, the present invention is not limited to these resins and other resins can be used to practice the invention.

In one embodiment, the pultrusions include re-enforcing fibers comprising, fiberglass fibers, composite fibers, etc. However, the present invention is not limited to these resins and other resins can be used to practice the invention.

One resin used in fiberglass pultrusions is a thermoset resin. The resin used in Polyvinyl Chloride (PVC) pultrusions are typical thermoplastic resins. In the pultrusion process, under heat and pressure, the rmoset resins and re-enforcing fibers form a new inert material that is impervious to temperature. Pultruded fiberglass physical properties do not change through the full temperature cycle up to temperatures of about 200 degrees Fahrenheit (° F.). In direct contrast, PVC resins typically become unstable at temperatures greater than 155° F. However, the present invention is not limited to such embodiments and other embodiments can also be used to practice the invention.

In one embodiment, the dice 108, 122-128, 130, 144 are 3D printed. A “3D printer” includes 3D printing or “Additive manufacturing.” 3D printing is a process of making a three-dimensional solid object of virtually any shape from a digital model. 3D printing is achieved using an “additive process,” where successive layers of material (e.g., plastics, composite materials, etc.) are laid down in different shapes. 3D printing is also considered distinct from traditional machining techniques, which mostly rely on the removal of material by methods such as cutting or drilling and are “subtractive” processes. However, the present invention is not limited to such embodiments and other embodiments can also be used to practice the invention.

In one embodiment, the plural protruding components and plural intruding components include additional fiberglass, plastic, ester, polyester, nylon, composite materials or other types of filaments or webbing to add additional strength to dice 108, 122-128, 130, 144. The filaments or webbing are applied internally or externally to the pultruded dice 108, 122-128, 130, 144. However, the present invention is not limited to such embodiments and other embodiments can also be used to practice the invention.

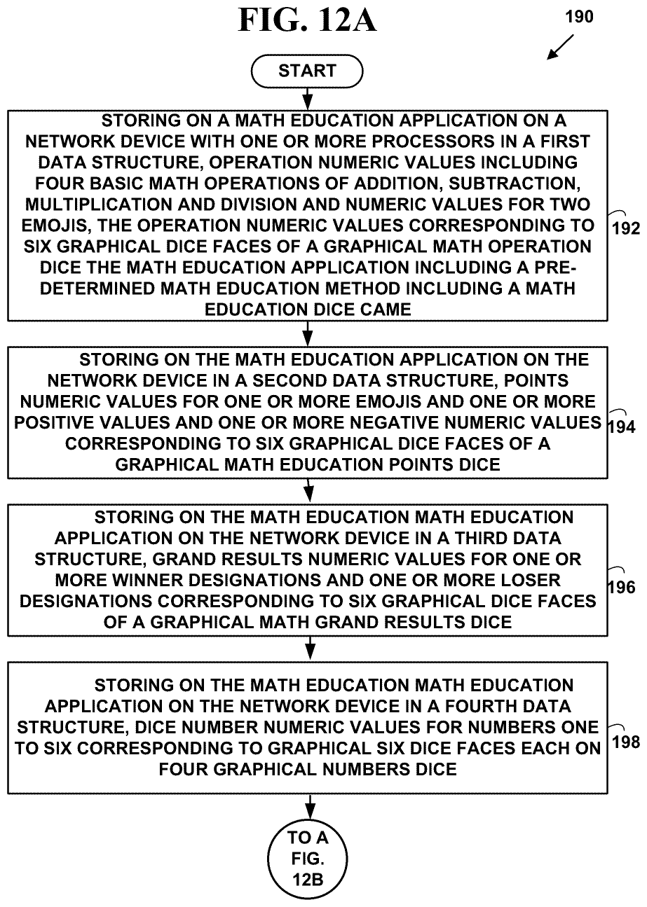

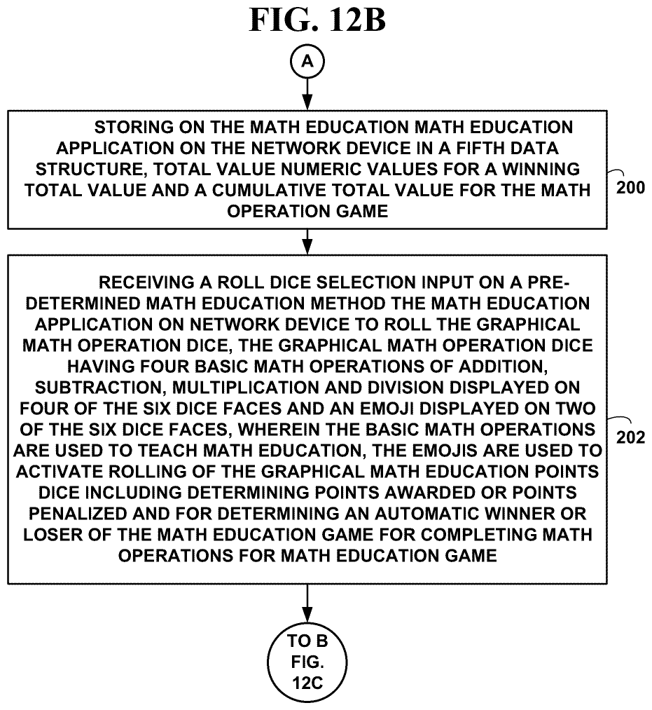

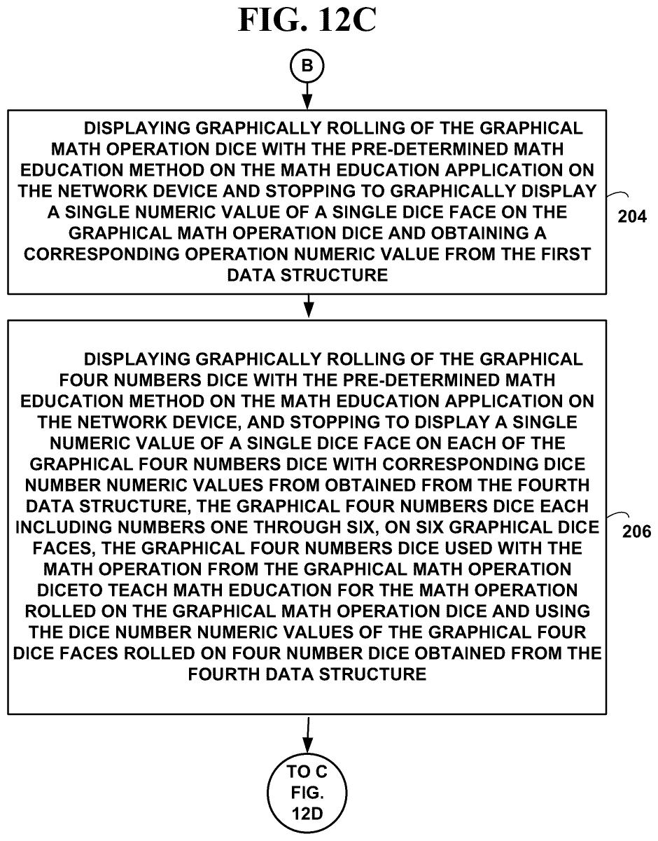

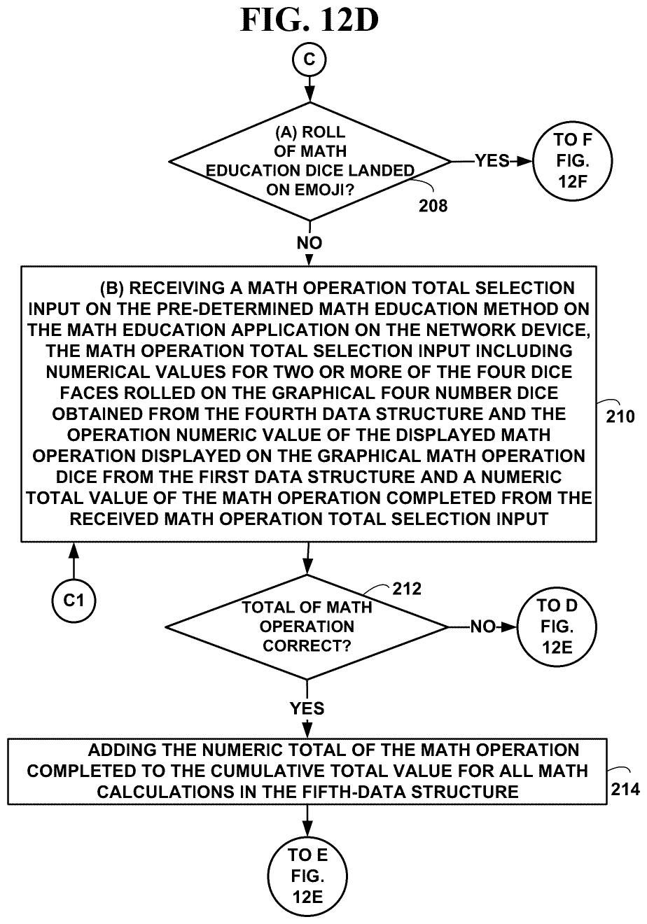

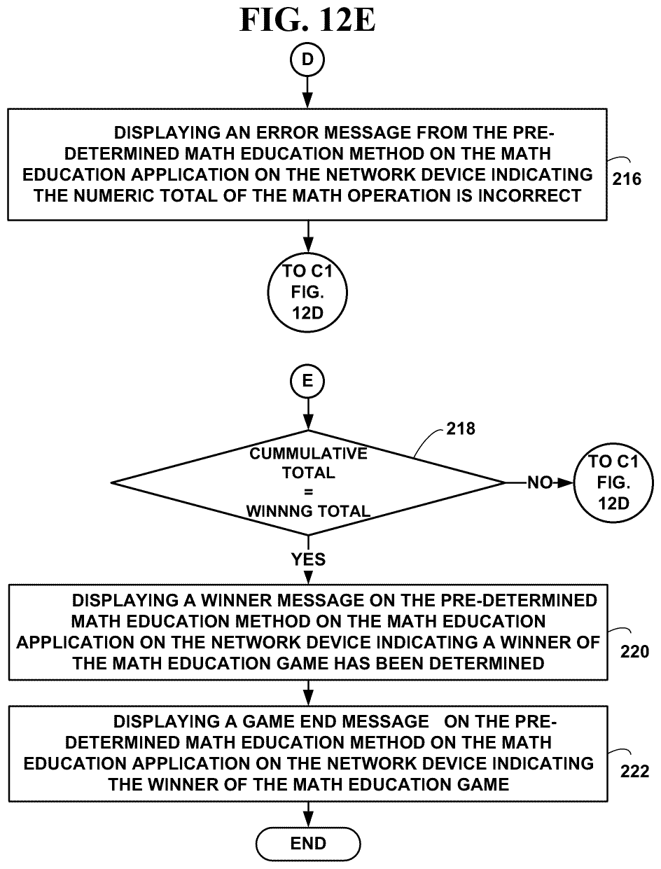

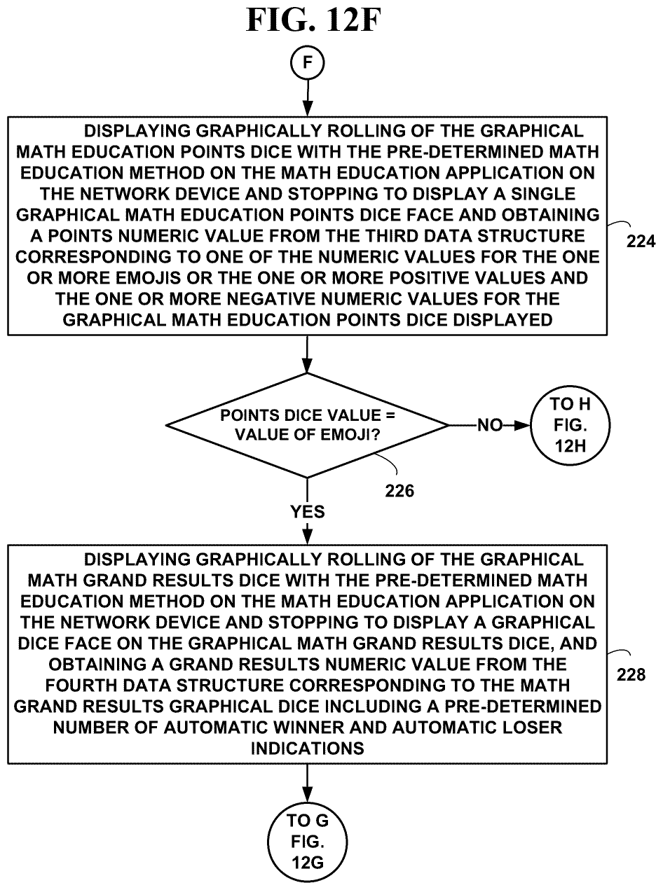

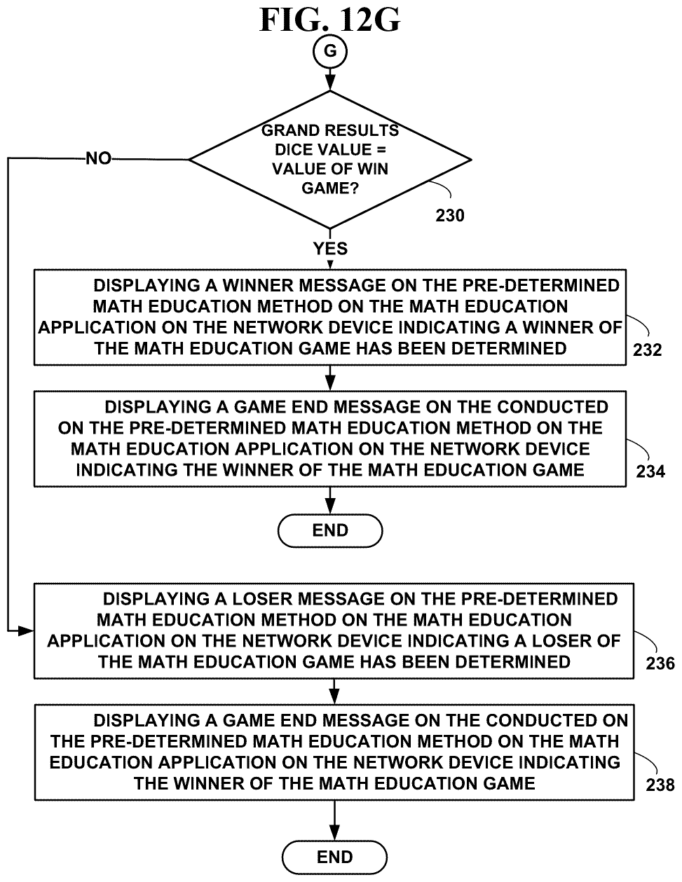

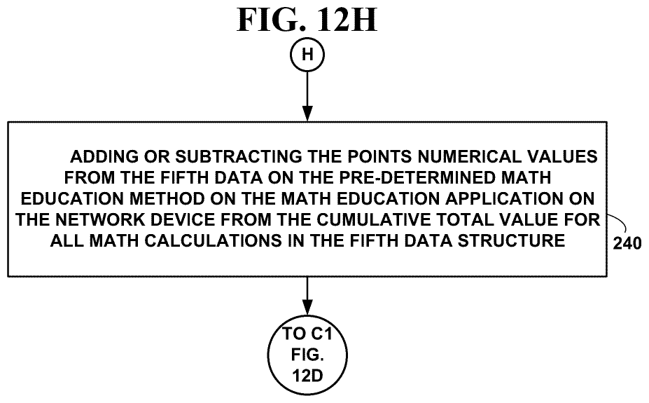

FIGS. 12A through 12H are a flow a Method 190 for math education with a dice game. In FIG. 12A at Step 192, storing on a math education application on a network device with one or more processors in a first data structure, operation numeric values including four basic math operations of addition, subtraction, multiplication and division and numeric values for two emojis, the operation numeric values corresponding to six graphical dice faces of a graphical math operation dice, the math education application including a pre-determined math education method including a math education dice came; At Step 194, storing on the math education application on the network device in a second data structure, points numeric values for one or more emojis and one or more positive values and one or more negative numeric values corresponding to six graphical dice faces of a graphical math education points dice; At Step 196, storing on the math education application on the network device in a third data structure, grand results numeric values for one or more winner designations and one or more loser designations corresponding to six graphical dice faces of a graphical math grand results dice; At Step 198, storing on the math education application on the network device in a fourth data structure, dice number numeric values for numbers one to six corresponding to graphical six dice faces each on four graphical numbers dice;

In FIG. 12B at Step 200 storing on the math education application on the network device in a fifth data structure, total value numeric values for a winning total value and a cumulative total value for the math operation game; At Step 202, receiving a roll dice selection input on a pre-determined math education method the math education application on network device to roll the graphical math operation dice, the graphical math operation dice having four basic math operations of addition, subtraction, multiplication and division displayed on four of the six dice faces and an emoji displayed on two of the six dice faces, wherein the basic math operations are used to teach math education, the emojis are used to activate rolling of the graphical math education points dice including determining points awarded or points penalized and for determining an automatic winner or loser of the math education dice game for completing math operations for the math education dice game.

In FIG. 12C at Step 204, displaying graphically rolling of the graphical math operation dice with the pre-determined math education method on the math education application on the network device and stopping to graphically display a single numeric value of a single dice face on the graphical math operation dice and obtaining a corresponding operation numeric value from the first data structure; At Step 206, displaying graphically rolling of the graphical four numbers dice with the pre-determined math education method on the math education application on the network device, and stopping to display a single numeric value of a single dice face on each of the graphical four numbers dice with corresponding dice number numeric values from obtained from the fourth data structure, the graphical four numbers dice each including numbers one through six, on six graphical dice faces, the graphical four numbers dice used with the math operation from the graphical math operation dice to teach math education for the math operation rolled on the graphical math operation dice and using the dice number numeric values of the graphical four dice faces rolled on four number dice obtained from the fourth data structure;

In FIG. 12D at Step 208 (a), a test is conducted with the pre-determined math education method on the math education application on the network device to determine if the operational numeric value from the first data structure for the math operation graphical math operation dice included an operation numeric value for an emoji, and if not, At Step 210 (b) receiving a math operation total selection input on the pre-determined math education method on the math education application on the network device, the math operation total selection input including numerical values for two or more of the four dice faces rolled on the graphical four number dice obtained from the fourth data structure and the operation numeric value of the displayed math operation displayed on the graphical math operation dice from the first data structure and a numeric total value of the math operation completed from the received math operation total selection input, At Step 212 (c), a test is conducted on the pre-determined math education method on the math education application on the network device to determine if the numeric total value of the math operation completed from the received math operation total selection input is correct, and at Step 214 if so, adding the numeric total of the math operation completed to the cumulative total value for all math calculations in the fifth-data structure, and

In FIG. 12E at Step 216 if not, displaying an error message from the pre-determined math education method on the math education application on the network device indicating the numeric total of the math operation is incorrect, and continuing the math education dice game at Step (b) until all math calculations are completed using math operation value rolled on the graphical math operation dice and the dice number numeric values of the graphical four dice faces rolled on the graphical four number dice, At Step 218 (d) a test is conducted from the pre-determined math education method on the math education application on the network device to determine if the cumulative total value for all math calculations is equal to a winning total value stored in the fifth data structure, and if so, At Step 220 displaying a winner message on the pre-determined math education method on the math education application on the network device indicating a winner of the math education dice game has been determined, At Step 222, displaying a game end message on the pre-determined math education method on the math education application on the network device indicating the winner of the math education dice game, and if not, the math education dice game continues at Step (b), until all math calculations are completed using math operation value rolled on the graphical math operation dice and the dice number numeric values of the graphical four dice faces rolled on the graphical four number dice, (e) if at Step (a) the specialized math education graphical dice rolled did land on a dice face with the emoji and includes an operation numeric value of the emoji,

and if so In FIG. 12F at Step 224, displaying graphically rolling of the graphical math education points dice with the pre-determined math education method on the math education application on the network device and stopping to display a single graphical math education points dice face and obtaining a points numeric value from the third data structure corresponding to one of the numeric values for the one or more emojis or the one or more positive values and the one or more negative numeric values for the graphical math education points dice displayed, At Step 226 (f), a test is conducted on the pre-determined math education method on the math education application on the network device, to determine if the graphical math education points dice displayed includes the points numeric value of the emoji, and if so, At Step 228 displaying graphically rolling of the graphical math grand results dice with the pre-determined math education method on the math education application on the network device and stopping to display a graphical dice face on the graphical math grand results dice, and obtaining a grand results numeric value from the fourth data structure corresponding to the math grand results graphical dice including a pre-determined number of automatic winner and automatic loser indications;

In FIG. 12G a Step 230 (g), a test is conducted with the pre-determined math education method on the math education application on the network device to determine if the roll of the graphical math grand results graphical dice includes the grand results numeric value from the fourth data structure indicating an automatic win of the game, and if so, At Step 232, displaying the winner message on the pre-determined math education method on the math education application on the network device indicating the winner of the math education dice game, and At Step 234, displaying the game end message on the conducted on the pre-determined math education method on the math education application on the network device indicating the winner of the math education dice game, and if not, At Step 236, displaying a loser message on the conducted on the pre-determined math education method on the math education application on the network device indicating the winner of the math education dice game, and At Step 238 displaying game end message on the conducted on the pre-determined math education method on the math education application on the network device indicating the loser of the math education dice game, and (h) if at Step (f) if the graphical math education points dice displayed does not include the points numeric value of emoji for the displayed single math education determination graphical dice face,

then In FIG. 12 H at Step 240 adding or subtracting the points numerical values from the fifth data on the pre-determined math education method on the math education application on the network device from the cumulative total value for all math calculations in the fifth data structure, and the math education dice game continues at Step (b), until all math calculations are completed using math operation value rolled on the graphical math operation dice and the dice number numeric values of the graphical four dice faces rolled on the graphical four number dice.

Method 190 is described with an illustrative embodiment. However, the present invention is not limited to such an embodiment and other embodiments can be used to practice the invention.

In such an illustrative embodiment in FIG. 12A at Step 192, storing on a math education application 30, 30a, 30c on a network device 12, 14, 16, 20, 22, 24, 26 31, 98-104 with one or more processors in a first data structure, operation numeric values including four basic math operations of addition 110, subtraction 112, multiplication 114 and division 116 and numeric values 118, 120 for two emojis, the operation numeric values corresponding to six graphical dice faces 110-120 of a graphical math operation dice 108, the math education application including a math education dice game 187, the math education application 30, 30a, 30c including a pre-determined math education method 30b including a math education dice came 187.

In one embodiment, the network device 12, 14, 16, 20, 22, 24, 26 31, 98-104 further includes graphics processing unit (GPU) to increase the speed of playing the math education dice game 187 on the network device 12, 14, 16, 20, 22, 24, 26 31, 98-104. However, the present invention is not limited to such an embodiment and other embodiments can also be used to practice the invention.

At Step 194, storing on the math education application 30, 30a, 30c on the network device 12, 14, 16, 20, 22, 24, 26 31, 98-104 in a second data structure, points numeric values for one or more emojis 132 and one or more positive values and one or more negative numeric values 134-142 corresponding to six graphical dice faces of a graphical math education points dice 130.

At Step 196, storing on the math education application 30, 30a, 30c on the network device 12, 14, 16, 20, 22, 24, 26 31, 98-104 in a third data structure, grand results numeric values for one or more winner designations and one or more loser designations 146-156 corresponding to six graphical dice faces of a graphical math grand results dice 144.

At Step 198, storing on the math education application 30, 30a, 30c on the network device, 14, 16, 20, 22, 24, 26 31, 98-104 in a fourth data structure, dice number numeric values for numbers one to six corresponding to graphical six dice faces each on four graphical numbers dice 122-128.

In FIG. 12B at Step 200 storing on the math education application 30, 30a, 30c on the network device 14, 16, 20, 22, 24, 26 31, 98-104 in a fifth data structure, total value numeric values for a winning total value and a cumulative total value for the math operation game 187.

In one embodiment, the first-data structure, the second data structure, the third data structure, the fourth data structure and the fifth data structure include data structures configured for storing numerical data easily accessible to be used by the M2M, NFC, infrared, RFID and BLUETOOTH communications protocols. In such an embodiment these data structures two network devices 14, 16, 20, 22, 24, 26 31, 98-104 to play the math operation game 187 without and/or with the communications network 18, 18′. In one embodiment, if the two network devices 14, 16, 20, 22, 24, 26 31, 98-104 are in close proximity (e.g., one to two feet), then the math operation game 187 can be played directly between the two network devices using the M2M, NFC, infrared, RFID and BLUETOOTH communications protocols without the communications network 18, 18′. However, the present invention is not limited to such an embodiment and other types of data structures can be used to practice the invention.

In one embodiment, the first-data structure, the second data structure, the third data structure, the fourth data structure and the fifth data structure include one or more of, data structures comprising, a search tree, a binary tree, a linked list and/or a combination thereof and/or other data structure.

A search tree includes a tree data structure that stores information for searching, where each node's key is greater than the keys in its left subtrees and less than the keys in its right subtrees.

A binary search tree includes also called an ordered or sorted binary tree, is a rooted binary tree data structure with a key of each internal node being greater than all the keys in a respective node's left subtree and less than the ones in its right subtree.

A linked list includes a linear collection of data elements whose order is not given by their physical placement in memory. Instead, each element in a linked list points to the next element where ever it may be located in memory. It is a data structure comprising f a collection of nodes which together represent a sequence. Each node in a linked list includes data, and a reference (i.e. an electronic link) to the next node in the sequence.

At Step 202, receiving a roll dice selection input 13, 13′, 15 on a pre-determined math education method 30b the math education application 30, 30a, 30c on network device 14, 16, 20, 22, 24, 26, 31, 98-104 to roll the graphical math operation dice 108, the graphical math operation dice 108 having four basic math operations of addition 110, subtraction 114, multiplication 116 and division 118 displayed on four of the six dice faces and an emoji 118, 120 displayed on two of the six dice faces, wherein the basic math operations are used to teach math education, the emojis 118, 120 are used to activate rolling of the graphical math education points dice 130 including determining points awarded 140-142 or points penalized 134-137 and for determining an automatic winner or loser of the math education dice game 187 for completing math operations for math education dice game 187. In one embodiment, the pre-determined math education method 30b the math education application 30, 30a, 30c on network device 14, 16, 20, 22, 24, 26, 31, 98-104, further includes a virtual points total summary sheet 157 earned playing the math education dice game 187 on the network device 14, 16, 20, 22, 24, 26, 31, 98-104. However, the present invention is not limited to such an embodiment and other embodiments may be used to practice the invention.

In one embodiment, the pre-determined math education method 30b includes, but is not limited to: (1) a random number generator method to generate random numbers to simulate rolling of all dice 108, 122-128, 130, 144 using data structures one to five; (2) a difficulty method to increase a difficulty and reduce a difficulty of the math operations presented addition 110, subtraction 112, multiplication 114 and division 116 on the specialized math education graphical dice 108; and (3) a combination method for automatically determining a number of possible combinations of operations 110-116 for each simulated roll of the four numbers dice 122-128. However, the present invention is not limited to such and embodiment and other embodiments may be used to practice the invention.

In one embodiment, the pre-determined math education method 30b includes. but is not limited to: (1) a method determining a grade level for math education; (2) a method for automatically adjusting a difficulty level for the math education based on the determined grade level; (3) adjusting numeric values for all dice faces in the first, second, third, fourth and fifty data structures; (4) a method for providing dynamic and different outcomes based on probabilities and possibilities of different dice faces occurring when rolled; and (5) a method recording and tracking math operation results and game outcomes. However, the present invention is not limited to such an embodiment and more, fewer and/or other methods can be used to practice the invention.

In one embodiment, the pre-determined math education method 30b includes, but is not limited to, one or more Artificial Intelligence (AI) methods 30c includes: (1) a AI random number generator method to generate random numbers to simulate rolling of all dice 108, 122-128, 130, 144 using data structures one to five; (2) a AI difficulty method to increase a difficulty and reduce a difficulty of the math operations presented addition 110, subtraction 112, multiplication 114 and division 116 on the specialized math education graphical dice 108; and (3) an AI combination method for automatically determining a number of possible combinations of operations 110-116 for each simulated roll of the four numbers dice 122-128. However, the present invention is not limited to such embodiments and other embodiments may be used to practice the invention.

In one embodiment, the Artificial Intelligence (AI) based methods 30c includes, but are not limited to: (1) an AI method determining a grade level for math education; (2) an AI method for automatically adjusting a difficulty level for the math education based on the determined grade level; (3) an AI method for automatically adjusting numeric values for all dice faces in the first, second, third, fourth and fifty data structures; (4) an AI method for providing dynamic and different outcomes based on probabilities and possibilities of different dice faces occurring when rolled; and (5) an AI method recording and tracking math operation results and game outcomes. However, the present invention is not limited to such an embodiment and more, fewer and/or other AI methods can be used to practice the invention.

In one embodiment, the pre-determined math education method 30b includes, but is not limited to, one or more SaaS 64 cloud services. In one embodiment, the math education application 30, 30a, 30c includes, but is not limited to, one or more cloud services SaaS 64. However, the present invention is not limited to such embodiments and other embodiments may be used to practice the invention.

In FIG. 12C at Step 204, displaying graphically rolling of the graphical math operation dice 108 with the pre-determined math education method 30b on the math education application 30, 30a, 30c on the network device 14, 16, 20, 22, 24, 26, 31, 98-104 and stopping to graphically display a single numeric value of a single dice face 110-120 on the graphical math operation dice 108 and obtaining a corresponding operation numeric value from the first data structure;

At Step 206, displaying graphically rolling of the graphical four numbers dice 122-128 with the pre-determined math education method 30b on the math education application 30, 30a, 30c on the network device 14, 16, 20, 22, 24, 26, 31, 98-104, and stopping to display a single numeric value of a single dice face on each of the graphical four numbers dice 122-126 with corresponding dice number numeric values from obtained from the fourth data structure, the graphical four numbers dice 122-126 each including numbers one through six, on six graphical dice faces, the graphical four numbers dice 122-126 used with the math operation from the graphical math operation dice 108 to teach math education for the math operation rolled on the graphical math operation dice 108 and using the dice number numeric values of the graphical four dice 122-126 faces rolled on four number dice obtained from the fourth data structure.

In one embodiment, random number generation is a method to generate sequence of numbers or symbols, such as randomly obtaining a numeric value or symbol on a dice face that cannot be reasonably predicted better than by random chance is generated. In one embodiment, the random number generation includes a hardware random-number generator (HRNGs), wherein each generation is a function of a current value of the network device physical hardware environment's attribute that is constantly changing. In another embodiment, the random number generation is done with software is called “pseudo-random number generators (PRNGs), which generate numbers that only look random but are in fact predetermined—these generations can be reproduced simply by knowing the state of the PRNG. However, the present invention is not limited to such embodiments and other random number generation methods can be used to practice the invention.

In FIG. 12D at Step 208 (a), a test is conducted with the pre-determined math education method 30b on the math education application 30, 30a, 30c on the network device 14, 16, 20, 22, 24, 26, 31, 98-104 to determine if the operational numeric value from the first data structure for the math operation graphical math operation dice 108 included an operation numeric value for an emoji 118, 120, and if not, At Step 210 (b) receiving a math operation total selection input 13t, 13t′ and 15t, on the pre-determined math education method 30b on the math education application 30, 30a, 30c on the network device 14, 16, 20, 22, 24, 26, 31, 98-104, the math operation total selection input 13t, 13t′ and 15t including numerical values for two or more of the four dice faces rolled on the graphical four number dice 122-129 obtained from the fourth data structure and the operation numeric value of the displayed math operation 110-116 displayed on the graphical math operation dice 108 from the first data structure and a numeric total value of the math operation completed from the received math operation total selection input 13t, 13t′ and 15t.

At Step 212 (c), a test is conducted on the pre-determined math education method 30b on the math education application 30, 30a, 30c on the network device 14, 16, 20, 22, 24, 26, 31, 98-104 to determine if the numeric total value of the math operation completed from the received math operation total selection input 13t, 13t′, 15t is correct, and at Step 214 if so, adding the numeric total of the math operation completed to the cumulative total value for all math calculations in the fifth-data structure.

In FIG. 12E at Step 216, if not, displaying an error message from the pre-determined math education method 30b on the math education application 30, 30a, 30c on the network device 14, 16, 20, 22, 24, 26, 31, 98-104 indicating the numeric total of the math operation is incorrect, and continuing the math education dice game at Step 210 (b) until all math calculations are completed using math operation value rolled on the graphical math operation dice 108 and the dice number numeric values of the graphical four dice faces rolled on the graphical four number dice 122-128.

At Step 218 (d) a test is conducted from the pre-determined math education method 30b on the math education application 30, 30a, 30c on the network device 14, 16, 20, 22, 24, 26, 31, 98-104 to determine if the cumulative total value for all math calculations is equal to a winning total value stored in the fifth data structure, and if so, At Step 220 displaying a winner message on the pre-determined math education method 30b on the math education application 30, 30a, 30c on the network device 14, 16, 20, 22, 24, 26, 31, 98-104 indicating a winner of the math education dice game has been determined.

At Step 222, displaying a game end message on the pre-determined math education method 30b on the math education application 30, 30a, 30c on the network device 14, 16, 20, 22, 24, 26, 31, 98-104 indicating the winner of the math education dice game, and if not, the math education dice game continues at Step 210 (b), until all math calculations are completed using math operation value rolled on the graphical math operation dice 108 and the dice number numeric values of the graphical four dice faces rolled on the graphical four number dice 122-128.

(e) if at Step 208 (a) the specialized math education graphical dice 108 rolled did land on a dice face with the emoji 118, 120 and includes an operation numeric value of the emoji, and if so In FIG. 12F at Step 224, displaying graphically rolling of the graphical math education points dice 130 with the pre-determined math education method 30b on the math education application 30, 30a, 30c on the network device 14, 16, 20, 22, 24, 26, 31, 98-104 and stopping to display a single graphical math education points dice 130 face 132-142 and obtaining a points numeric value from the third data structure corresponding to one of the numeric values for the one or more emojis 132 or the one or more positive values 140, 142 and the one or more negative numeric values 134, 136-138 for the graphical math education points dice 130 displayed.

At Step 226 (f), a test is conducted on the pre-determined math education method 30b on the math education application 30, 30a, 30c on the network device 14, 16, 20, 22, 24, 26, 31, 98-104, to determine if the graphical math education points dice 130 displayed includes the points numeric value of the emoji 132, and if so, At Step 228 displaying graphically rolling of the graphical math grand results dice 144 with the pre-determined math education method 30b on the math education application 30, 30a, 30c on the network device 14, 16, 20, 22, 24, 26, 31, 98-104 and stopping to display a graphical dice face 146-156 on the graphical math grand results dice 144, and obtaining a grand results numeric value from the fourth data structure corresponding to the math grand results graphical dice 144 including a pre-determined number of automatic winner and automatic loser indications.

In FIG. 12G a Step 230 (g), a test is conducted with the pre-determined math education method 30b on the math education application 30, 30a, 30c on the network device 14, 16, 20, 22, 24, 26, 31, 98-104 to determine if the roll of the graphical math grand results graphical dice 144 includes the grand results numeric value from the fourth data structure indicating an automatic win 146-15 of the game, and if so, At Step 232, displaying the winner message on the pre-determined math education method 30b on the math education application 30, 30a, 30c on the network device indicating the winner of the math education dice game 187; and

At Step 234, displaying the game end message on the conducted on the pre-determined math education method 30b on the math education application 30, 30a, 30c on the network device 14, 16, 20, 22, 24, 26, 31, 98-104 indicating the winner of the math education dice game 187, and if not, At Step 236, displaying a loser message on the conducted on the pre-determined math education method 30b on the math education application 30, 30a, 30c on the network device 14, 16, 20, 22, 24, 26, 31, 98-104 indicating the winner of the math education dice game 187, and At Step 238 displaying game end message on the conducted on the pre-determined math education method 30b on the math education application 30, 30a, 30c on the network device 14, 16, 20, 22, 24, 26, 31, 98-104 indicating the loser of the math education dice game 187, and (h) if at Step (f) if the graphical math education points dice 130 displayed does not include the points numeric value of emoji 132 for the displayed single math education determination graphical dice 108 face,

then In FIG. 12 H at Step 240 adding or subtracting the points numerical values from the fifth data on the pre-determined math education method 30b on the math education application 30, 30a, 30c on the network device 14, 16, 20, 22, 24, 26, 31, 98-104 from the cumulative total value for all math calculations ‘57 in the fifth data structure, and the math education dice game 187 continues at Step (b), until all math calculations are completed using math operation value rolled on the graphical math operation dice 108 and the dice number numeric values of the graphical four dice faces rolled on the graphical four number dice 122-128.

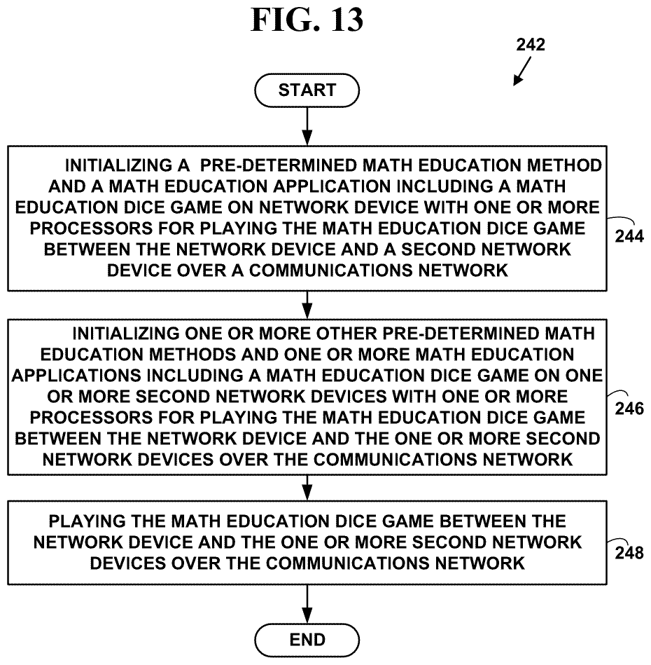

FIG. 13 is a flow diagram illustrating a Method 242 for a multi-player math education dice game.

In FIG. 13 at Step 244, initializing a pre-determined math education method and a math education application including a math education dice game on network device with one or more processors for playing the math education dice game between the network device and a second network device over a communications network; at Step 246, Initializing one or more other pre-determined math education methods and one more or second math education applications including a math education dice game on one or more second network devices with one or more processors for playing the math education dice game between the network device and the one or more second network devices over a communications network; and at Step 248 playing the math education dice game between the network device and the one or more second network devices over the communications network.

Method 244 is described with an illustrative embodiment. However, the present invention is not limited to such an embodiment and other embodiments can be used to practice the invention.

In such an illustrative embodiment in FIG. 13 at Step 244, initializing a pre-determined math education method 30b and a math education application 30, 30a, 30c including a math education dice game 187 on network device 14, 16, 20, 22, 24, 26, 31, 98-104 with one or more processors for playing the math education dice game 187 between the network device 14, 16, 20, 22, 24, 26, 31, 98-104 and a second network device 14, 16, 20, 22, 24, 26, 31, 98-104 over a communications network 18, 18′.

At Step 246, Initializing one or more other pre-determined math education methods 30b′, and one or more second math education applications 30′, 30a′, 30c′ including a math education dice game 187 on one or more second network devices 14, 16, 20, 22, 24, 26, 31, 98-104 with one or more processors for playing the math education dice game 187 between the network device 14, 16, 20, 22, 24, 26, 31, 98-104 and the one or more second network devices 14, 16, 20, 22, 24, 26, 31, 98-104 over the communications network 18, 18′

At Step 248 playing the math education dice game 187 between the network device 14, 16, 20, 22, 24, 26, 31, 98-104 and the one or more second network devices 14, 16, 20, 22, 24, 26, 31, 98-104 over the communications network 18, 18′.

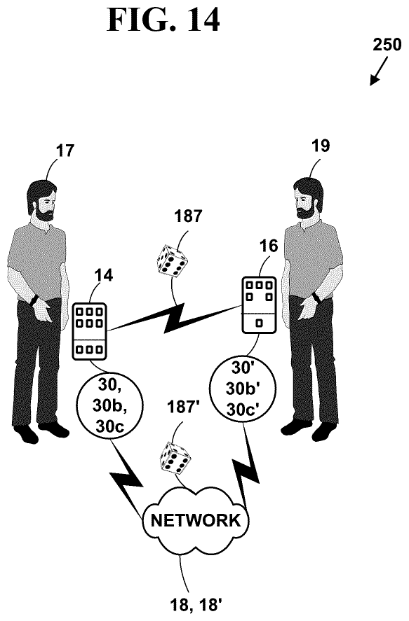

FIG. 14 is a block diagram illustrating a data flow 250 for multi-player math education dice game.

In FIG. 14, illustrates a first user 17 playing the math education dice game 187 with a second 19 with the two network devices 14, 16, in close proximity (e.g., one to two feet), then the math operation game 187 is played directly between the two network devices using the M2M, NFC, infrared, RFID and BLUETOOTH communications protocols without the communications network 18, 18′. However, the present invention is not limited to such embodiments and other embodiments can be used to practice the invention.

FIG. 14, also illustrates the first user 17 playing the math education dice game 187′ with the second 19 with the two network devices 14, 16, in communications over the communications network 18, 18′. However, the present invention is not limited to such embodiments and other embodiments can be used to practice the invention.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended. Therefore, all embodiments that come within the scope and spirit of the following claims and equivalents thereto are claimed as the invention.

I claim:

1. A method for math education with a dice game, comprising:
storing on a math education application on a network device with one or more processors in a first data structure, operation numeric values including four basic math operations of addition, subtraction, multiplication and division and numeric values for two emojis, the operation numeric values corresponding to six graphical dice faces of a graphical math operation dice,
the math education application including a pre-determined math education method including a math education dice came;
storing on the math education application on the network device in a second data structure, points numeric values for one or more emojis and one or more positive values and one or more negative numeric values corresponding to six graphical dice faces of a graphical math education points dice;
storing on the math education application on the network device in a third data structure, grand results numeric values for one or more winner designations and one or more loser designations corresponding to six graphical dice faces of a graphical math grand results dice;
storing on the math education application on the network device in a fourth data structure, dice number numeric values for numbers one to six corresponding to graphical six dice faces, each on four graphical numbers dice;
storing on the math education application on the network device in a fifth data structure, total value numeric values for a winning total value and a cumulative total value for the math education dice game;
receiving a roll dice selection input on the pre-determined math education method on the math education application on the network device to roll the graphical math operation dice,
the graphical math operation dice having four basic math operations of addition, subtraction, multiplication and division displayed on four of the six dice faces and an emoji displayed on two of the six dice faces, wherein the basic math operations are used to teach math education, the emojis are used to activate rolling of the graphical math education points dice including determining points awarded or points penalized and for determining an automatic winner or loser of the math education dice game for completing math operations for the math education dice game;
displaying graphically rolling of the graphical math operation dice with the pre-determined math education method on the math education application on the network device and stopping to graphically display a single numeric value of a single dice face on the graphical math operation dice and obtaining a corresponding operation numeric value from the first data structure;
displaying graphically rolling of the graphical four numbers dice with the pre-determined math education method on the math education application on the network device, and stopping to display a single numeric value of a single dice face on each of the graphical four numbers dice with corresponding dice number numeric values from obtained from the fourth data structure,
the graphical four numbers dice each including numbers one through six, on six graphical dice faces, the graphical four numbers dice used with the math operation from the graphical math operation dice to teach math education for the math operation rolled on the graphical math operation dice and using the dice number numeric values of the graphical four dice faces rolled on four number dice obtained from the fourth data structure;
(a) a test is conducted with the pre-determined math education method on the math education application on the network device to determine if the operational numeric value from the first data structure for the math operation graphical math operation dice included an operation numeric value for an emoji, and if not,
(b) receiving a math operation total selection input on the pre-determined math education method on the math education application on the network device,
the math operation total selection input including numerical values for two or more of the four dice faces rolled on the graphical four number dice obtained from the fourth data structure and the operation numeric value of the displayed math operation displayed on the graphical math operation dice from the first data structure and a numeric total value of the math operation completed from the received math operation total selection input,
(c) a test is conducted on the pre-determined math education method on the math education application on the network device to determine if the numeric total value of the math operation completed from the received math operation total selection input is correct, and
if so, adding the numeric total of the math operation completed to the cumulative total value for all math calculations in the fifth-data structure, and
if not, displaying an error message from the pre-determined math education method on the math education application on the network device indicating the numeric total of the math operation is incorrect, and
continuing the math education dice game at Step (b) until all math calculations are completed using math operation value rolled on the graphical math operation dice and the dice number numeric values of the graphical four dice faces rolled on the graphical four number dice,
(d) a test is conducted from the pre-determined math education method on the math education application on the network device to determine if the cumulative total value for all math calculations is equal to a winning total value stored in the fifth data structure, and if so,
displaying a winner message on the pre-determined math education method on the math education application on the network device indicating a winner of the math education dice game has been determined,
displaying a game end message on the pre-determined math education method on the math education application on the network device indicating the winner of the math education dice game,
and if not,
the math education dice game continues at Step (b), until all math calculations are completed using math operation value rolled on the graphical math operation dice and the dice number numeric values of the graphical four dice faces rolled on the graphical four number dice,
(e) if at Step (a) the specialized math education graphical dice rolled did land on a dice face with the emoji and includes an operation numeric value of the emoji, and if so
displaying graphically rolling of the graphical math education points dice with the pre-determined math education method on the math education application on the network device and stopping to display a single graphical math education points dice face and obtaining a points numeric value from the third data structure corresponding to one of the numeric values for the one or more emojis or the one or more positive values and the one or more negative numeric values for the graphical math education points dice displayed,
(f) a test is conducted on the pre-determined math education method on the math education application on the network device, to determine if the graphical math education points dice displayed includes the points numeric value of the emoji, and if so,
displaying graphically rolling of the graphical math grand results dice with the pre-determined math education method on the math education application on the network device and stopping to display a graphical dice face on the graphical math grand results dice, and obtaining a grand results numeric value from the fourth data structure corresponding to the math grand results graphical dice including a pre-determined number of automatic winner and automatic loser indications;
(g) a test is conducted with the pre-determined math education method on the math education application on the network device to determine if the roll of the graphical math grand results graphical dice includes the grand results numeric value from the fourth data structure indicating an automatic win of the game, and if so,
displaying the winner message on the pre-determined math education method on the math education application on the network device indicating the winner of the math education dice game, and
displaying the game end message on the conducted on the pre-determined math education method on the math education application on the network device indicating the winner of the math education dice game,
and if not,
displaying a loser message on the conducted on the pre-determined math education method on the math education application on the network device indicating the winner of the math education dice game, and
displaying game end message on the conducted on the pre-determined math education method on the math education application on the network device indicating the loser of the math education dice game, and
(h) if at Step (f) if the graphical math education points dice displayed does not include the points numeric value of emoji for the displayed single math education determination graphical dice face, then
adding or subtracting the points numerical values from the fifth data on the pre-determined math education method on the math education application on the network device from the cumulative total value for all math calculations in the fifth data structure, and
the math education dice game continues at Step (b), until all math calculations are completed using math operation value rolled on the graphical math operation dice and the dice number numeric values of the graphical four dice faces rolled on the graphical four number dice.

2. The method for math education with a dice game of claim 1, wherein the network device includes: desktop computers and laptop computers, tablet computers, mobile phones, non-mobile phones with displays, smart phones, Internet phones, Internet appliances, personal digital/data assistants (PDA), portable, handheld and desktop video game devices, Internet of Things (IoT) devices, cable television (CATV), satellite television (SATV) and Internet television set-top boxes, digital televisions including high definition television (HDTV), three-dimensional (3DTV) televisions, wearable network devices smart speakers or other types of network devices.

3. The method for math education with a dice game of claim 1, wherein the pre-determined math education method includes one or more of: (1) a random number generator method to generate random numbers to simulate rolling of all dice using data structures one to five; (2) a difficulty method to increase a difficulty and reduce a difficulty of the math operations presented addition subtraction multiplication and division on the specialized math education graphical dice; and (3) a combination method for automatically determining a number of possible combinations of operations for each simulated roll of the four numbers dice.

4. The method for math education with a dice game of claim 1, wherein the pre-determined math education method includes one or more of: (1) a method for determining a grade level for math education; (2) a method for automatically adjusting a difficulty level for the math education based on the determined grade level; (3) a method adjusting numeric values for all dice faces in the first, second, third, fourth and fifty data structures; (4) a method for providing dynamic and different outcomes based on probabilities and possibilities of different dice faces occurring when rolled; and (5) a method recording and tracking math operation results and game outcomes.

5. The method for math education with a dice game of claim 1, wherein the pre-determined math education method includes Artificial Intelligence (AI) methods for one or more of: (1) an AI method for random number generator method to generate random numbers to simulate rolling of all dice using data structures one to five; (2) an AI difficulty method to increase a difficulty and reduce a difficulty of the math operations presented addition subtraction multiplication and division on the specialized math education graphical dice; and (3) an AI combination method for automatically determining a number of possible combinations of operations for each simulated roll of the four numbers dice.

6. The method for math education with a dice game of claim 1, wherein the pre-determined math education method includes Artificial Intelligence (AI) methods for one or more of: (1) an AI method determining a grade level for math education; (2) an AI method for automatically adjusting a difficulty level for the math education based on the determined grade level; (3) an AI method for automatically adjusting numeric values for a number of emojis in the first data structure and the second data structure; (4) an AI method providing dynamic and different outcomes based on probabilities and possibilities of different dice faces occurring when rolled; and (5) an AI method for recording and tracking math operation results and game outcomes.

7. The method for math education with a dice game of claim 1, wherein the first data structure, second data structure, third data structure, fourth data structure and fifth data structure, include one or more of: a search tree data structure, a binary search tree data structure or a link list data structure or a combination thereof.

8. The method for math education with a dice game of claim 1, wherein the first data structure, second data structure, third data structure, fourth data structure and fifth data structure, include data structures configured for storing numerical data easily accessible to be used by Machine-2-Machine (M2M), Near Field Communications (NFC), infrared, or RFID, communications protocols.

9. The method for math education with a dice game of claim 1, further including:
a communications network;
one or more second network device with one or more processors with one or more second pre-determined math education methods and one or more second math education applications;
playing the math education dice game between the network device and the one or more second network devices over the communications network.

10. The method for math education with a dice game of claim 1, further including:
the network device including a first set of data structures configured for storing numerical data easily accessible to be used by Machine-2-Machine (M2M), Near Field Communications (NFC), infrared, or RFID, or a combination thereof, communications protocols;
a second network device with one or more processors with a second pre-determined math education method and a second math education application,
the second network device including a second set of data structures configured for storing numerical data easily accessible to be used by Machine-2-Machine (M2M), Near Field Communications (NFC), infrared, RFID, or a combination thereof, communications protocols;
placing the network device and the second network device at a pre-determined maximum distance between the network device and the second network device; and
playing the math education dice game between the network device and the second network device over the maximum distance using one or more of the M2M, NFC, infrared, RFID, or a combination thereof, communications protocols.

11. The method for math education with a dice game of claim 10, wherein
the minimal distance maximum distance between the network device and the second network device includes about twelve inches.

12. The method for math education with a dice game of claim 1, further including:
a cloud communications network,
one or more cloud server network devices,
one or more cloud databases;
one or more cloud storage objects in the one or more cloud databases; and
a cloud computing Infrastructure as a Service (IaaS), including a cloud software infrastructure service, a cloud platform as a Service (PaaS) including a cloud software platform service and one or more cloud Software as a Services (SaaS), including a specific SaaS, for math education services,
wherein the one or more cloud storage objects include Representational state transfer (REST), Simple Object Access Protocol (SOAP), Lightweight Directory Access Protocol (LDAP) or Application Programming Interface (API) objects.

13. The method for math education with a dice game of claim 1, wherein the network device further includes graphics processing unit (GPU) to increase the speed of playing the math education dice game on the network device.

14. The method for math education with a dice game of claim 1, wherein the pre-determined math education method the math education application on network device further includes a virtual points total summary sheet to record point earned playing the math education dice game on the network device.

15. A non-transitory computer readable medium have stored therein a plurality of instructions for causing one or more processors to execute the steps of:
storing on a math education application on a network device with one or more processors in a first data structure, operation numeric values including four basic math operations of addition, subtraction, multiplication and division and numeric values for two emojis, the operation numeric values corresponding to six graphical dice faces of a graphical math operation dice,
the math education application including a pre-determined math education method including a math education dice came;
storing on the math education application on the network device in a second data structure, points numeric values for one or more emojis and one or more positive values and one or more negative numeric values corresponding to six graphical dice faces of a graphical math education points dice;
storing on the math education application on the network device in a third data structure, grand results numeric values for one or more winner designations and one or more loser designations corresponding to six graphical dice faces of a graphical math grand results dice;
storing on the math education application on the network device in a fourth data structure, dice number numeric values for numbers one to six corresponding to graphical six dice faces, each on four graphical numbers dice;
storing on the math education application on the network device in a fifth data structure, total value numeric values for a winning total value and a cumulative total value for the math education dice game;
receiving a roll dice selection input on the pre-determined math education method on the math education application on the network device to roll the graphical math operation dice,
the graphical math operation dice having four basic math operations of addition, subtraction, multiplication and division displayed on four of the six dice faces and an emoji displayed on two of the six dice faces, wherein the basic math operations are used to teach math education, the emojis are used to activate rolling of the graphical math education points dice including determining points awarded or points penalized and for determining an automatic winner or loser of the math education dice game for completing math operations for the math education dice game;
displaying graphically rolling of the graphical math operation dice with the pre-determined math education method on the math education application on the network device and stopping to graphically display a single numeric value of a single dice face on the graphical math operation dice and obtaining a corresponding operation numeric value from the first data structure;
displaying graphically rolling of the graphical four numbers dice with the pre-determined math education method on the math education application on the network device, and stopping to display a single numeric value of a single dice face on each of the graphical four numbers dice with corresponding dice number numeric values from obtained from the fourth data structure,
the graphical four numbers dice each including numbers one through six, on six graphical dice faces, the graphical four numbers dice used with the math operation from the graphical math operation dice to teach math education for the math operation rolled on the graphical math operation dice and using the dice number numeric values of the graphical four dice faces rolled on four number dice obtained from the fourth data structure;
(a) a test is conducted with the pre-determined math education method on the math education application on the network device to determine if the operational numeric value from the first data structure for the math operation graphical math operation dice included an operation numeric value for an emoji, and if not,
(b) receiving a math operation total selection input on the pre-determined math education method on the math education application on the network device,
the math operation total selection input including numerical values for two or more of the four dice faces rolled on the graphical four number dice obtained from the fourth data structure and the operation numeric value of the displayed math operation displayed on the graphical math operation dice from the first data structure and a numeric total value of the math operation completed from the received math operation total selection input,
(c) a test is conducted on the pre-determined math education method on the math education application on the network device to determine if the numeric total value of the math operation completed from the received math operation total selection input is correct, and
if so, adding the numeric total of the math operation completed to the cumulative total value for all math calculations in the fifth-data structure, and
if not, displaying an error message from the pre-determined math education method on the math education application on the network device indicating the numeric total of the math operation is incorrect, and
continuing the math education dice game at Step (b) until all math calculations are completed using math operation value rolled on the graphical math operation dice and the dice number numeric values of the graphical four dice faces rolled on the graphical four number dice,
(d) a test is conducted from the pre-determined math education method on the math education application on the network device to determine if the cumulative total value for all math calculations is equal to a winning total value stored in the fifth data structure, and if so,
displaying a winner message on the pre-determined math education method on the math education application on the network device indicating a winner of the math education dice game has been determined,
displaying a game end message on the pre-determined math education method on the math education application on the network device indicating the winner of the math education dice game,
and if not,
the math education dice game continues at Step (b), until all math calculations are completed using math operation value rolled on the graphical math operation dice and the dice number numeric values of the graphical four dice faces rolled on the graphical four number dice,
(e) if at Step (a) the specialized math education graphical dice rolled did land on a dice face with the emoji and includes an operation numeric value of the emoji, and if so
displaying graphically rolling of the graphical math education points dice with the pre-determined math education method on the math education application on the network device and stopping to display a single graphical math education points dice face and obtaining a points numeric value from the third data structure corresponding to one of the numeric values for the one or more emojis or the one or more positive values and the one or more negative numeric values for the graphical math education points dice displayed,
(f) a test is conducted on the pre-determined math education method on the math education application on the network device, to determine if the graphical math education points dice displayed includes the points numeric value of the emoji, and if so,
displaying graphically rolling of the graphical math grand results dice with the pre-determined math education method on the math education application on the network device and stopping to display a graphical dice face on the graphical math grand results dice, and obtaining a grand results numeric value from the fourth data structure corresponding to the math grand results graphical dice including a pre-determined number of automatic winner and automatic loser indications;
(g) a test is conducted with the pre-determined math education method on the math education application on the network device to determine if the roll of the graphical math grand results graphical dice includes the grand results numeric value from the fourth data structure indicating an automatic win of the game, and if so,
displaying the winner message on the pre-determined math education method on the math education application on the network device indicating the winner of the math education dice game, and
displaying the game end message on the conducted on the pre-determined math education method on the math education application on the network device indicating the winner of the math education dice game,
and if not,
displaying a loser message on the conducted on the pre-determined math education method on the math education application on the network device indicating the winner of the math education dice game, and
displaying game end message on the conducted on the pre-determined math education method on the math education application on the network device indicating the loser of the math education dice game, and
(h) if at Step (f) if the graphical math education points dice displayed does not include the points numeric value of emoji for the displayed single math education determination graphical dice face, then
adding or subtracting the points numerical values from the fifth data on the pre-determined math education method on the math education application on the network device from the cumulative total value for all math calculations in the fifth data structure, and
the math education dice game continues at Step (b), until all math calculations are completed using math operation value rolled on the graphical math operation dice and the dice number numeric values of the graphical four dice faces rolled on the graphical four number dice.

16. A math education dice game system, comprising in combination:
a network device with one or more processors including a math education application with a pre-determined math education method including a math education dice came including a plurality of instructions:
for storing on the math education application on the network device in a first data structure, operation numeric values including four basic math operations of addition, subtraction, multiplication and division and numeric values for two emojis, the operation numeric values corresponding to six graphical dice faces of a graphical math operation dice;
for storing on the math education application on the network device in a second data structure, points numeric values for one or more emojis and one or more positive values and one or more negative numeric values corresponding to six graphical dice faces of a graphical math education points dice;
for storing on the math education application on the network device in a third data structure, grand results numeric values for one or more winner designations and one or more loser designations corresponding to six graphical dice faces of a graphical math grand results dice;
for storing on the math education application on the network device in a fourth data structure, dice number numeric values for numbers one to six corresponding to graphical six dice faces, each on four graphical numbers dice;
for storing on the math education application on the network device in a fifth data structure, total value numeric values for a winning total value and a cumulative total value for the math education dice game;
for receiving a roll dice selection input on the pre-determined math education method on the math education application on the network device to roll the graphical math operation dice,
the graphical math operation dice having four basic math operations of addition, subtraction, multiplication and division displayed on four of the six dice faces and an emoji displayed on two of the six dice faces, wherein the basic math operations are used to teach math education, the emojis are used to activate rolling of the graphical math education points dice including determining points awarded or points penalized and for determining an automatic winner or loser of the math education dice game for completing math operations for the math education dice game;
for displaying graphically rolling of the graphical math operation dice with the pre-determined math education method on the math education application on the network device and stopping to graphically display a single numeric value of a single dice face on the graphical math operation dice and obtaining a corresponding operation numeric value from the first data structure;
for displaying graphically rolling of the graphical four numbers dice with the pre-determined math education method on the math education application on the network device, and stopping to display a single numeric value of a single dice face on each of the graphical four numbers dice with corresponding dice number numeric values from obtained from the fourth data structure,
the graphical four numbers dice each including numbers one through six, on six graphical dice faces, the graphical four numbers dice used with the math operation from the graphical math operation dice to teach math education for the math operation rolled on the graphical math operation dice and using the dice number numeric values of the graphical four dice faces rolled on four number dice obtained from the fourth data structure;
(a) for conducting a test with the pre-determined math education method on the math education application on the network device to determine if the operational numeric value from the first data structure for the math operation graphical math operation dice included an operation numeric value for an emoji, and if not,
(b) for receiving a math operation total selection input on the pre-determined math education method on the math education application on the network device,
the math operation total selection input including numerical values for two or more of the four dice faces rolled on the graphical four number dice obtained from the fourth data structure and the operation numeric value of the displayed math operation displayed on the graphical math operation dice from the first data structure and a numeric total value of the math operation completed from the received math operation total selection input,
(c) for conducting a test on the pre-determined math education method on the math education application on the network device to determine if the numeric total value of the math operation completed from the received math operation total selection input is correct, and
if so, for adding the numeric total of the math operation completed to the cumulative total value for all math calculations in the fifth-data structure, and
if not, for displaying an error message from the pre-determined math education method on the math education application on the network device indicating the numeric total of the math operation is incorrect, and
for continuing the math education dice game at Step (b) until all math calculations are completed using math operation value rolled on the graphical math operation dice and the dice number numeric values of the graphical four dice faces rolled on the graphical four number dice,
(d) for conducting a test from the pre-determined math education method on the math education application on the network device to determine if the cumulative total value for all math calculations is equal to a winning total value stored in the fifth data structure, and if so,
for displaying a winner message on the pre-determined math education method on the math education application on the network device indicating a winner of the math education dice game has been determined,
for displaying a game end message on the pre-determined math education method on the math education application on the network device indicating the winner of the math education dice game,
and if not,
for continuing the math education dice game at Step (b), until all math calculations are completed using math operation value rolled on the graphical math operation dice and the dice number numeric values of the graphical four dice faces rolled on the graphical four number dice,
(e) if at Step (a) the specialized math education graphical dice rolled did land on a dice face with the emoji and includes an operation numeric value of the emoji, and if so,
for displaying graphically rolling of the graphical math education points dice with the pre-determined math education method on the math education application on the network device and stopping to display a single graphical math education points dice face and obtaining a points numeric value from the third data structure corresponding to one of the numeric values for the one or more emojis or the one or more positive values and the one or more negative numeric values for the graphical math education points dice displayed,
(f) for conducting a test on the pre-determined math education method on the math education application on the network device, to determine if the graphical math education points dice displayed includes the points numeric value of the emoji, and if so,
displaying graphically rolling of the graphical math grand results dice with the pre-determined math education method on the math education application on the network device and stopping to display a graphical dice face on the graphical math grand results dice, and obtaining a grand results numeric value from the fourth data structure corresponding to the math grand results graphical dice including a pre-determined number of automatic winner and automatic loser indications;
(g) for conducting a test with the pre-determined math education method on the math education application on the network device to determine if the roll of the graphical math grand results graphical dice includes the grand results numeric value from the fourth data structure indicating an automatic win of the game, and if so,
for displaying the winner message on the pre-determined math education method on the math education application on the network device indicating the winner of the math education dice game, and
for displaying the game end message on the conducted on the pre-determined math education method on the math education application on the network device indicating the winner of the math education dice game,
and if not,
for displaying a loser message on the conducted on the pre-determined math education method on the math education application on the network device indicating the winner of the math education dice game, and
for displaying game end message on the conducted on the pre-determined math education method on the math education application on the network device indicating the loser of the math education dice game, and
(h) if at Step (f) if the graphical math education points dice displayed does not include the points numeric value of emoji for the displayed single math education determination graphical dice face, then
for adding or subtracting the points numerical values from the fifth data on the pre-determined math education method on the math education application on the network device from the cumulative total value for all math calculations in the fifth data structure, and
for continuing the math education dice game Step (b), until all math calculations are completed using math operation value rolled on the graphical math operation dice and the dice number numeric values of the graphical four dice faces rolled on the graphical four number dice.

17. The math education dice game system of claim 16, further including:
a communications network;
a second network device with one or more processors with a second pre-determined math education method and a second math education application;
for playing the math education dice game between the network device and the second network device over the communications network.

18. The math education dice game system of claim 16, further including:
the network device including a first set of data structures configured for storing numerical data easily accessible to be used by Machine-2-Machine (M2M), Near Field Communications (NFC), infrared, or RFID, or a combination thereof, communications protocols;
a second network device with one or more processors with a second pre-determined math education method and a second math education application,
the second network device including a second set of data structures configured for storing numerical data easily accessible to be used by Machine-2-Machine (M2M), Near Field Communications (NFC), infrared, RFID, or a combination thereof, communications protocols;
for placing the network device and the second network device at a pre-determined maximum distance between the network device and the second network device; and
for playing the math education dice game between the network device and the second network device over the maximum distance using one or more of the M2M, NFC, infrared, RFID, or a combination thereof, communications protocols.

19. A math education dice game comprising:
a six-sided math operation dice with four faces of the math operation dice including graphical symbols for mathematical operations comprising: addition, subtraction, multiplication and division for completing a plurality of mathematical operations for a math education dice game and two faces of the math operation dice including graphical symbols for a first set of two emojis, the first set of two emojis when rolled cause for or more six-sided number dice to be rolled and a six-sided math points dice to be rolled;
four or more six-sided number dice, each including the numbers one through six on individual six-sides of the six-sided number dice, the four or more six-sided number dice rolled to provide numbers to complete the mathematical operations on and create a math education dice game points total;
the six-sided math points dice including four faces of the six-sided math points dice including graphical symbols for one or more positive numbers and one or more negative numbers for adding to or subtracting from the math education dice game points total and two faces of the math operation dice including graphical symbols for a second set of two emojis, the second set of two emojis when rolled cause a six-sided grand results dice to be rolled;
the six-sided grand results dice including at least one graphical symbol indicating an automatic winner of the math education dice game and at least one graphical symbol indicating an automatic winner of the math education dice game; and
a points total summary sheet for keeping track of total points earned playing the math education dice game.

20. The math education dice game of claim 19, wherein the six-sided math operation dice, four or more six-sided number dice, the six-sided math points dice and the six-sided grand results dice comprise wood, paper, plastic, metal, composite materials or a combination thereof.
